(19) United States
(12) Patent Application Publication
(10) Pub. No.: US 2012/0210077 A1
(43) Pub. Date: Aug. 16, 2012

(54) RECORDING SYSTEM, RECORDING METHOD AND COMPUTER PROGRAM

(75) Inventors: Hiromasa HOSHINO, Osaka (JP); Daisuke HAYASHI, Nara (JP); Hidefumi MURAOKA, Osaka (JP)

(73) Assignee: PANASONIC CORPORATION, Osaka (JP)

(21) Appl. No.: 13/366,417

(22) Filed: Feb. 6, 2012

(30) Foreign Application Priority Data
Feb. 10, 2011 (JP) 2011-026832
Jan. 13, 2012 (JP) 2012-005337

(51) Int. Cl. G06F 12/00

(52) U.S. Cl. 711/154; 711/E12.001

(57) ABSTRACT

A recording system includes a controller configured to write content data on at least first and second storage media, in parallel with each other. If there is a period in which the content data has failed to be written on the first storage medium but has been written successfully on the second storage medium, the controller finds, on the first storage medium, a storage space, of which the size is equal to or greater than that of partial data that is the content data that has been written successfully on the second storage medium during the period, and writes recovery information on one or more storage media other than the first storage medium. The recovery information includes some pieces of information to identify the first storage medium, to specify the storage space, and to define an area on the second storage medium on which the partial data has been written.

### BACKGROUND OF THE INVENTION

1. Field of the Invention

The present invention relates to a technique for writing the same piece of information on multiple information storage media redundantly. More particularly, the present invention relates to a technique for writing the same piece of information about video captured on multiple information storage media redundantly so that even if any part of video data has failed to be written on one of those storage media, that missing part of the information can be recovered.

2. Description of the Related Art

It is known that some image capture devices (such as camcorders) can write data of video being captured (which will be referred to herein as “video data”) on multiple storage media simultaneously and in duplicate. By writing such video data redundantly, the video captured can be saved without missing any part of it because even if any part of the video data has failed to be written on one of those storage media, that part should be written on the other.

Japanese Patent Application Laid-Open Publication No. 2004-328037 (which will be referred to herein as “Patent Document No. 1” for convenience sake) discloses multiple recorders on which image information can be written at the same time. First of all, according to Patent Document No. 1, each of multiple recorders, on which image data needs to be written and transferred at the same time, has its attribute information checked out to see if the device should be subjected to simultaneous write operations. If the answer is NO, then the image data will not be written simultaneously on that recorder while continuous write operations such as sequential shooting sessions are being carried out. When the series of sequential shooting sessions is over, however, the image data will be retrieved from another recorder on which the data has been written successfully, and then the image data retrieved is transferred to, and written on, that recorder that was excluded from the simultaneous write operations first time around. As a result, the image data can be eventually retained on multiple recorders in parallel with each other while satisfying a predetermined continuous write rate.

Using such recorders, however, it takes a lot of time to get the series of image data write operations all done. Specifically, according to Patent Document No. 1, after the series of continuous write operations is over, every piece of the image data is retrieved from the recorders on which the image data has been written, and then the image data retrieved is transferred to, and written on, recorders that were excluded from the simultaneous write operations first time around. If such a timing-consuming series of operations should be done, the user cannot start the next series of continuous write operations immediately after the first series is over, but has no choice but to wait patiently. Then, the reliability of the recorders will be sacrificed.

However, recorders for professional use, in particular, need to have such reliability. This is because if a recorder that cannot respond to a shooter's instant request to start a write operation as quickly as possible, he or she cannot record video data to be broadcast, for example, thus possibly causing a lot of damage on him or her. Furthermore, even if the recorder could respond to the instant start of write operations but if any part of the video data failed to be written, then that missing part of the video data should be recovered as quickly and as accurately as possible.

### SUMMARY OF THE INVENTION

It is therefore an object of the present invention to carry out continuous write operations just as intended and get recovery processing done as quickly as possible even if any part of the video data has failed to be written.

A recording system according to the present invention includes: a write buffer configured to temporarily accumulate content data to be generated sequentially; and a controller configured to write the content data that is accumulated in the write buffer on each of multiple storage media, including first and second storage media, in parallel with each other. If there is a period in which the content data has failed to be written on the first storage medium but has been written successfully on the second storage medium, the controller finds, on the first storage medium, a storage space, of which the size is equal to or greater than that of partial data that is the content data that has been written successfully on the second storage medium during the period, and writes recovery information on at least one of the storage media other than the first storage medium. The recovery information includes: a first piece of information that identifies the first storage medium on which the partial data has failed to be written; a second piece of information that specifies the storage space; and a third piece of information that defines an area on the second storage medium on which the partial data has been written.

The controller may generate, as the second piece of information, information that indicates the beginning and end of the storage space.

The controller may generate, as the third piece of information, information that defines the starting point and the end point of the area on the second storage medium on which the partial data has been written.

The controller may write blank information, including the second piece of information that specifies the storage space, on the first storage medium.

The write buffer may delete, on a predetermined data unit basis, the content data that has been written on the first and second storage media. And the controller may determine, based on the data size of the content data that is accumulated in the write buffer, that the content data is unable to be written on the first storage medium.

If the data size of the content data that is accumulated in the write buffer does not exceed a predetermined threshold value, the controller may determine that the content data is ready to start being written on the first storage medium again and may retry the operation of writing the content data.

If the recovery information has been written on at least one of the storage media other than the first storage medium, the controller may retrieve the recovery information, may determine whether the first storage medium, which is identified by the first piece of information and on which the partial data has failed to be written, is connected or not. If the first storage medium is connected, the controller may retrieve the partial data from the area on the second storage medium by reference to the third piece of information, and may write the partial data retrieved on the storage space that is specified by the second piece of information.

If there is a period in which the content data has failed to be written on the first storage medium but has been written successfully on the second storage medium and an n^{th} storage medium (where n is an integer that is equal to or greater than three), the controller may write the recovery information on both of the second storage medium and the n^{th} storage medium.

If there is a period in which the content data has failed to be written on the first storage medium but has been written successfully on the second storage medium and an n^{th} storage medium (where n is an integer that is equal to or greater than three), the controller may write the recovery information on one of the second and n^{th} storage media that has turned out to have the higher degree of reliability than the other according to a predefined standard.

The write buffer and the controller may be arranged inside a single housing, and multiple storage media may be attachable to, and removable from, the recording system.

The recording system may further include a video input section configured to receive sequentially, as the content data, video data of a subject that has been shot.

The recording system may include: a first recorder, which includes the write buffer, the controller and a first telecommunications section configured to transmit the content data and which writes the content data on one of the first and second storage media, and a second recorder, which includes a second telecommunications section configured to receive the content data from the first recorder and configured to write the content data received on the other of the first and second storage media.

A recording method according to the present invention is a method to be performed by a recording system that includes: a write buffer configured to temporarily accumulate content data to be generated sequentially; and a controller configured to write the content data that is accumulated in the write buffer on each of multiple storage media, including first and second storage media, in parallel with each other. If there is a period in which the content data has failed to be written on the first storage medium but has been written successfully on the second storage medium, the method comprises the steps of: making the controller find, on the first storage medium, a storage space, of which the size is equal to or greater than that of partial data that is the content data that has been written successfully on the second storage medium during the period, and making the controller write recovery information on at least one of the storage media other than the first storage medium. The recovery information includes: a first piece of information that identifies the first storage medium on which the partial data has failed to be written; a second piece of information that specifies the storage space; and a third piece of information that defines an area on the second storage medium on which the partial data has been written.

A computer program according to the present invention is executed by a computer of a recording system that includes: a write buffer configured to temporarily accumulate content data to be generated sequentially; and the computer configured to write the content data that is accumulated in the write buffer on each of multiple storage media, including first and second storage media, in parallel with each other. If there is a period in which the content data has failed to be written on the first storage medium but has been written successfully on the second storage medium, the computer program is defined to make the computer perform the steps of: finding, on the first storage medium, a storage space, of which the size is equal to or greater than that of partial data that is the content data that has been written successfully on the second storage medium during the period, and writing recovery information on at least one of the storage media other than the first storage medium. The recovery information includes: a first piece of information that identifies the first storage medium on which the partial data has failed to be written; a second piece of information that specifies the storage space; and a third piece of information that defines an area on the second storage medium on which the partial data has been written.

According to a preferred embodiment of the present invention, a write operation is performed with a storage space, which should be needed when the write operation is continued, left on a storage medium, thereby speeding up the recovery processing. In addition, by compiling recovery information that is required to recover information from the storage space left and writing the recovery information on any the storage media on which a write operation will be performed continuously, the recovery information can be saved just as intended.

Other features, elements, processes, steps, characteristics and advantages of the present invention will become more apparent from the following detailed description of preferred embodiments of the present invention with reference to the attached drawings.

### BRIEF DESCRIPTION OF THE DRAWINGS

FIGS. 1A and 1B illustrate exemplary arrangements of a recording system according to the present invention.

FIG. 2 is a block diagram illustrating a configuration for a video recorder 100 as a first specific preferred embodiment of the present invention.

FIG. 3 is a flowchart showing the general procedure of the processing to be carried out by the video recorder 100.

FIG. 4 illustrates how the CPU 101 manages the write buffer 103 and the storage media 110 and 111.

FIG. 5 is a flowchart showing the procedure of the write processing to be carried out by the video recorder 100 of the first preferred embodiment of the present invention.

FIG. 6 illustrates how the video data has been written on the storage media 110 and 111.

FIG. 7 shows an example of the recovery information to be stored in the main memory 102.

FIG. 8 is a flowchart showing the procedure of recovery information compiling processing.

FIG. 9 illustrates the writing and storage statuses of the storage media 110 and 111 when the operation of writing the video data on the storage medium 111 is resumed.

FIG. 10 shows an example of the recovery information to which the end of the blank area and the recovery end point have been added.

FIG. 11 shows an example of the blank information.

FIG. 12 is a flowchart showing the procedure of the writing resume processing.

FIG. 13 is a flowchart showing the procedure of the recovery processing.

FIG. 14 is a block diagram illustrating a configuration for a video recorder 1100 as a second specific preferred embodiment of the present invention.

FIG. 15 is a block diagram illustrating a configuration for an external device 1200 according to the second preferred embodiment of the present invention.

FIG. 16 is a flowchart showing the procedure of write operations according to the second preferred embodiment.

FIG. 17 illustrates the writing and storage statuses of the storage medium 1110 and the storage medium 1203 that is connected to the external device 1200.

FIG. 18 illustrates, as file images, the writing and storage statuses of the storage media 1110 and 1203 when the video data starts to be transmitted again to the external device 1200.

FIG. 19 is a flowchart showing the procedure of the writing/transmitting resume processing.

FIG. 20 shows a list of transmitted files.

### DETAILED DESCRIPTION OF PREFERRED EMBODIMENTS

Hereinafter, preferred embodiments of a recording system according to the present invention will be described with reference to the accompanying drawings.

First of all, a recording system according to the present invention writes content data on multiple storage media, including first and second storage media, in parallel with each other. Thus, the content data can be saved without missing any part of it. In performing a write operation, even if the recording system has failed to write content data on a first storage medium, the recording system continues writing the content data on the second storage medium. And when ready to resume the write operation on the first storage medium, the recording system leaves a storage space, of which the size is large enough to store the missing part (i.e., partial data) of the content data that has failed to be written on the first storage medium, on the first storage medium and starts writing the content data again right after that storage space left. As a result, that partial data can be written afterward on that storage space left after the write operation is finished. By adopting such a scheme, the content data can be saved without missing any part of it, and another content can start being written immediately after the former content has been written completely.

In this description, video and/or audio in any form will be collectively referred to herein as a “content”. In the preferred embodiments of the present invention to be described below, it will be described as an example how to write video data, which is an exemplary form of content data, in parallel.

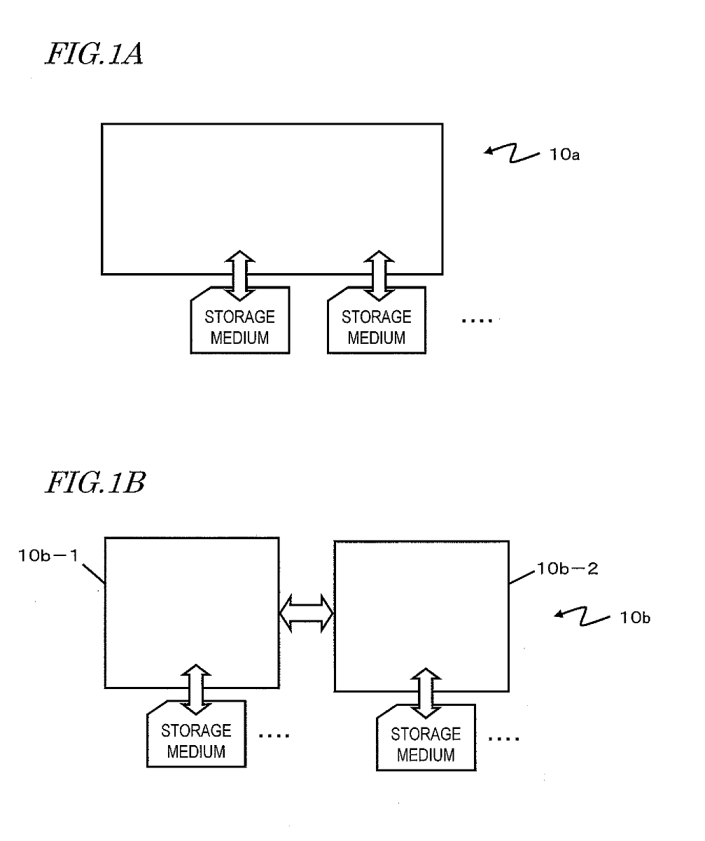

FIGS. 1A and 1B illustrate exemplary arrangements of a recording system according to the present invention.

FIG. 1A illustrates a recording system 10a, which is implemented as a recorder that has every component thereof integrated together in a single housing. The recording system 10a can write video data on multiple storage media, which are provided for the same recorder, in parallel with each other. The first preferred embodiment of the present invention to be described below uses this basic arrangement shown in FIG. 1A.

On the other hand, FIG. IB illustrates a recording system 10b consisting of a number of recorders 10b-1 through 10b-n (where n is an integer that is equal to or greater than one). Each of those recorders has at least one storage medium. For example, a recorder 10b-1, which has generated video data, not only writes the video data on its own storage medium but also transmits that video data to another recorder 10b-2 at the same time. In response, the recorder 10b-2 receives that video data and writes it on its own storage medium. As a result, the video data can be written on multiple storage media in parallel with each other. The second preferred embodiment of the present invention to be described later uses this basic arrangement shown in FIG. 1B.

Hereinafter, respective preferred embodiments of the present invention will be described.

### Embodiment 1

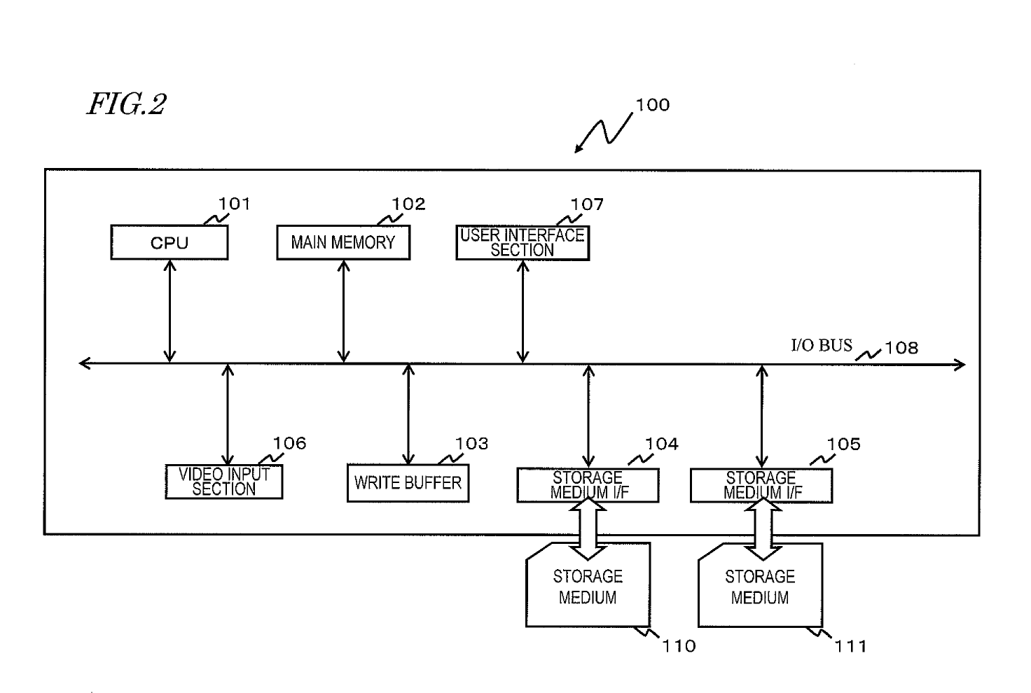

FIG. 2 is a block diagram illustrating a configuration for a video recorder 100 as a first specific preferred embodiment of the present invention. The video recorder 100 includes a CPU 101, a main memory 102, a write buffer 103, storage medium interfaces (I/Fs) 104 and 105, a video input section 106, a user interface section 107, and an input/output (I/O) bus 108.

The CPU 101 is a central processing unit, which is built in a computer system, for example. Using the main memory 102, the CPU 101 carries out various kinds of programs, thereby functioning as a controller that controls the overall operation of this video recorder 100. For example, the CPU 101 gets the video data that has been temporarily stored in the write buffer 103 written on the multiple storage media 110 and 111 by the storage medium I/Fs 104 and 105 in parallel with each other.

The video input section 106 is either an analog interface (I/F) or a digital I/F. In this preferred embodiment, the video input section 106 is supposed to be a digital I/F, which may be an HD-SDI (high definition serial digital interface) or an IEEE 1394, for example.

The video input section 106 receives a digital video signal (which will be referred to herein as “video data”) and outputs the video data to the write buffer 103. Optionally, the video recorder 100 may function as a recording mechanism that is built in another device. For example, the video recorder 100 may be implemented as a recording mechanism for a camera recorder (not shown), which includes an optical system for capturing a subject image and the recording mechanism for writing the video data captured on a storage medium. In that case, the video input section 106 receives the video data that has been captured by an image capturing mechanism or processing section of the camera recorder.

The storage medium I/F 104 is an interface that connects the storage medium 110 to this video recorder 100 and that contributes to exchanging data between the storage medium 110 and the video recorder 100. Likewise, the storage medium I/F 105 is an interface that connects the storage medium 111 to this video recorder 100 and that contributes to exchanging data between the storage medium 111 and the video recorder 100.

The storage media 110 and 111 may be SD (secure digital) memory cards and are attachable and removable to/from this video recorder 100. The storage media 110 and 111 do not have to be SD memory cards but may also be any other randomly accessible storage media such as Compact Flash cards, Multi Media cards, DVD-RAMS or Blu-ray Discs.

In this preferred embodiment, the storage media 110 and 111 are supposed to be of the same type and have the same maximum storage capacity. However, this is just an example of the present invention, and the storage media 110 and 111 may be of mutually different types. For example, the storage medium 110 may be an SD memory card and the storage medium 111 may be a Compact Flash card. Also, the storage media 110 and 111 may have mutually different maximum storage capacities, too.

The user interface section 107 accepts the user's instruction to start or stop recording video, for example, and passes his or her instruction accepted to the CPU 101 through the I/O bus 108.

The I/O bus 108 is arranged inside of this video recorder 100 in order to transmit data through it. That is to say, the I/O bus 108 makes it possible to exchange data between multiple components of this video recorder 100.

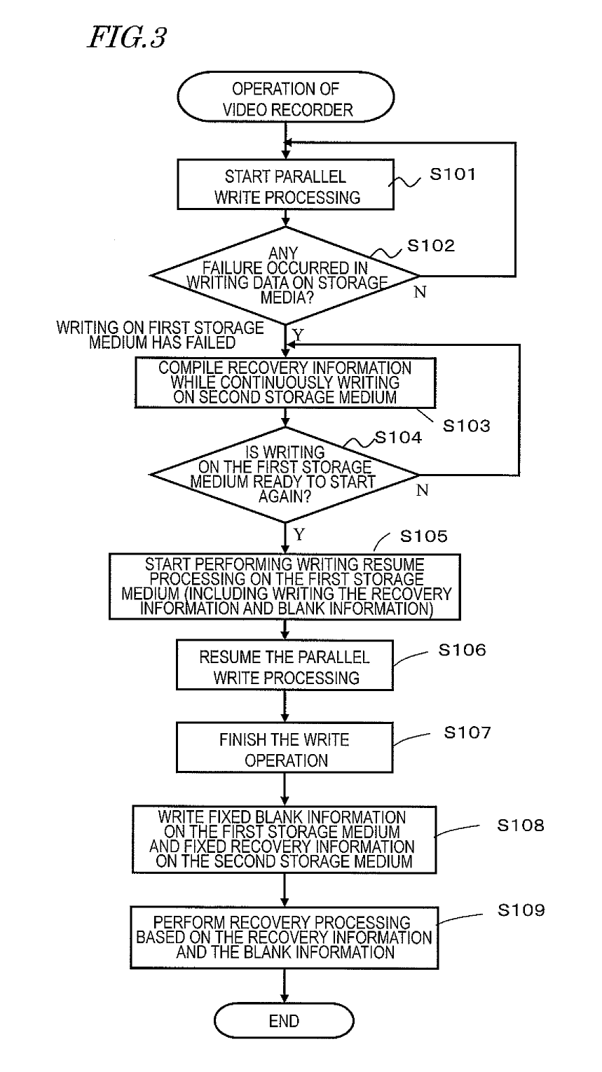

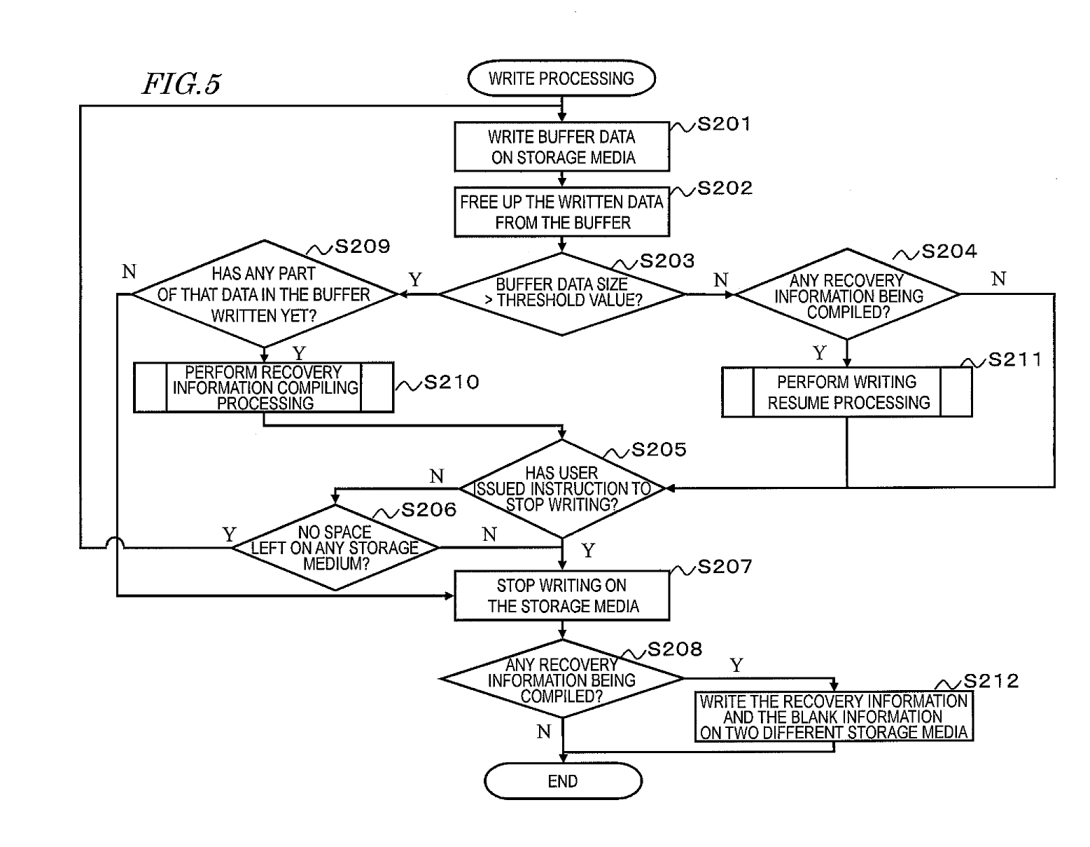

Hereinafter, the general procedure of the processing to be carried out by this video recorder 100 will be described with reference to FIG. 3. After that, each of those processing steps will be described in detail with reference to the drawings from FIG. 5 on.

FIG. 3 is a flowchart showing the general procedure of the processing to be carried out by this video recorder. 100. In the example illustrated in FIG. 3, the number of storage media to use is supposed to be two and those storage media will be referred to herein as a “first storage medium” and a “second storage medium”, respectively. In the following description of this preferred embodiments, however, the first storage medium corresponds to the storage medium 111 (see FIG. 2) and the second storage medium corresponds to the storage medium 110 (see FIG. 2, too).

First of all, the CPU 101 of the video recorder 100 starts parallel write processing in Step S101. Once the parallel write processing is started, the CPU 101 determines continuously whether or not any failure has occurred in writing video data on the two storage media (in Step S102). In this example, the video data is supposed to have failed to be written on the first storage medium but to be being written successfully on the second storage medium.

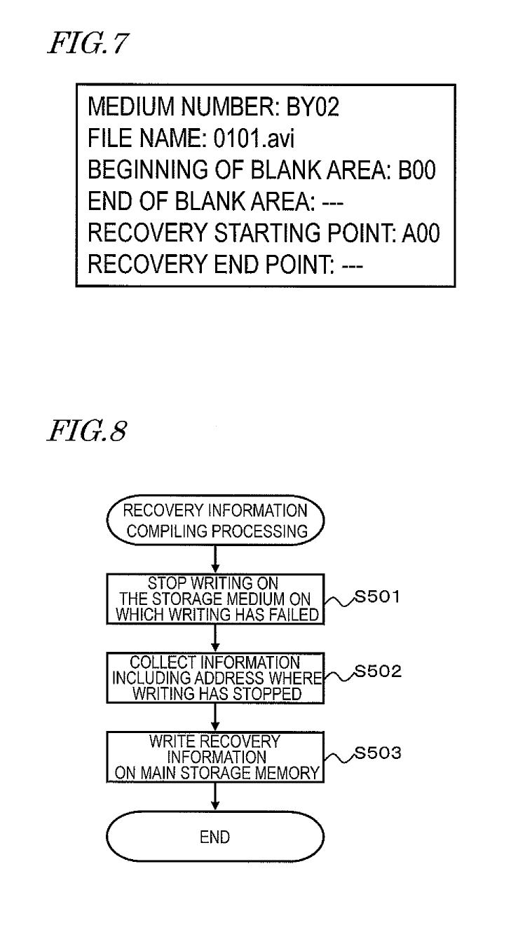

If the CPU 101 has determined that the video data has failed to be written, then the CPU 101 compiles recovery information (see FIG. 7) while continuously writing the video data on the second storage medium (in Step S103). In this description, the “recovery information” refers herein to a piece of information that will be needed to write that missing part of the video data on the first storage medium when the video data is ready to be written on the first storage medium afterward. In this example, the “recovery information” includes a piece of information that identifies the first storage medium, the name of a file on which the data had been written successfully until the write error occurred, and information defining the range of the video data when the write error occurred.

In this description, such a failure of writing video data on a storage medium is supposed to occur just temporarily and that missing part of the video data is supposed to be written properly after that by making a retry, for example. That is why even if video data cannot be written properly at a point in time, that video data could be written successfully afterward. For that reason, in the processing step S102, instead of stopping the write operation even if a write error has occurred only once, retries may be carried out a number of times unless the size of the video data that has not been written on the storage medium yet exceeds a threshold value. And when the threshold value is exceeded, the write operation may be stopped. The threshold value is a reference value that is used for writing video data, which is generated one after another during shooting, on the storage media without missing any part of it. Once the size of the video data that has not been written yet has exceeded the threshold value, even if the video data is continuously being written on the second storage medium, frequent retries of writing on the first storage medium could prevent the system from going on to write new video data yet to be written. As a result, some video data could never be written and lost forever. Thus, to avoid missing any part of the video data in this manner, once the threshold value has been exceeded, the CPU determines that the write operation on the first storage medium has failed completely and that the write operation on the second storage medium be prioritized.

After that, until the operation of writing the video data on the first storage medium is ready to start again, the CPU 101 gets the video data written continuously on the second storage medium (in Step S104).

If the operation of writing the video data on the first storage medium is not yet ready to resume, then the process goes back to the processing step S103. In that case, however, no new set of recovery information is compiled in Step S103. That is to say, only a single set of recovery information needs to be used after it has been determined that an error occurred in writing the video data and until the operation of writing the video data is resumed next time. However, if a write error occurs again after the operation of writing the video data has been resumed, then a new set of recovery information is compiled.

When the CPU 101 senses that the operation of writing the video data on the first storage medium is ready to resume, the CPU 101 starts performing writing resume processing on the first storage medium (in Step S105). In this example, the CPU 101 writes the recovery information on the second storage medium, on which the video data has been written continuously, and also writes blank information on the first storage medium on which the video data has failed to be written. In this description, the “blank information” refers to a piece of information about an area on which the missing part of the video data should have been written. More specifically, the “blank information” is a piece of information about the first storage medium on which the CPU has determined the video data cannot be written.

After that, the CPU 101 resumes the parallel write processing in Step S106 and continues it until the write operation is finished due to the end of shooting in Step S107.

When the write operation is finished, the CPU 101 writes the recovery information, which has been fixed due to the end of the write operation, on the second storage medium, and also writes the blank information, which has also been fixed due to the end of the write operation, on the first storage medium (in Step S108).

Thereafter, the CPU 101 performs recovery processing based on the recovery information and the blank information in Step S109. As a result of the recovery processing, that missing part of the video data that was generated in the period in which the write operation could not be performed on the first storage medium is copied onto the first storage medium. Consequently, as if no error had occurred in writing the video data, the video data can be written on the second storage medium and the same video data can eventually be written on the first storage medium without missing any part of it.

In this example, the recovery processing step S109 is supposed to be carried out immediately after the CPU 101 has determined that the write operation has ended. However, this is only an example of the present invention. Alternatively, the recovery processing may also be performed after a predetermined amount of time has passed since the write operation ended, not just after the end of the write operation. Or according to the random accessibility of the first and second storage media, the recovery processing may even be started right after the parallel write processing has been resumed. In that case, the recovery processing will need to be performed while the sequentially generated video data is written in parallel. Optionally, only the recovery processing could be carried out by another device, instead of the video recorder 100.

Hereinafter, the respective processing steps will be described in further detail.

But before that, the relation between the write buffer 103 and the storage media 110 and 111 shown in FIG. 2 will be described. In this preferred embodiment, the write buffer 103 is supposed to be a ring buffer.

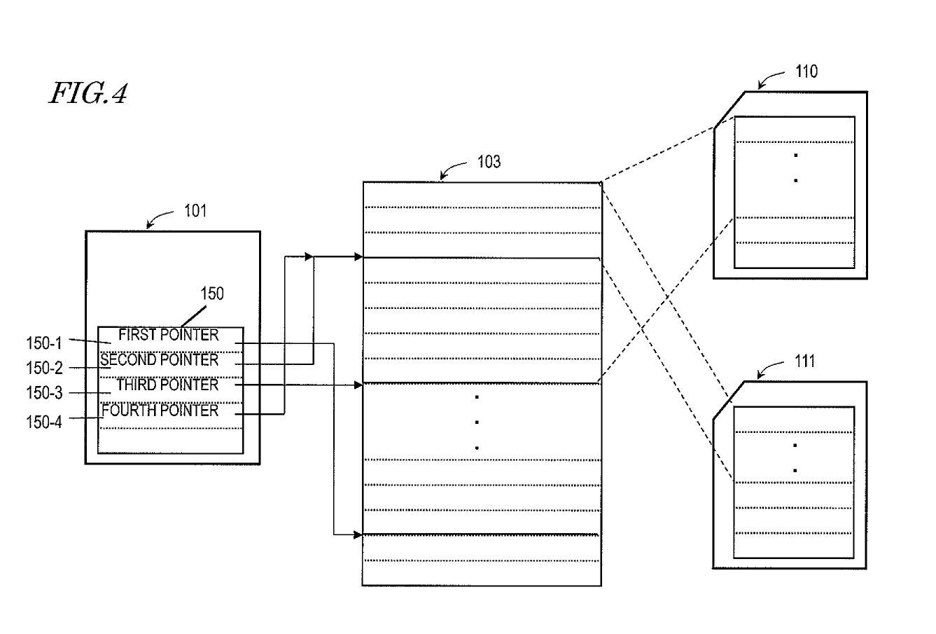

FIG. 4 illustrates how the CPU 101 manages the write buffer 103 and the storage media 110 and 111.

The CPU 101 retains at least four pointers 150-1 through 150-n (where n is an integer that is equal to or greater than four) in its internal register 150. Each of these pointers indicates an address value at the write buffer 103.

Specifically, the first pointer 150-1 points to the location of the newest part of the video data that has just been written in the write buffer 103. On the other hand, the second pointer 150-2 points to the location of the oldest part of the video data that was written in the write buffer 103 earlier than any other part of the video data.

In this case, the relation between these two locations pointed to by the first and second pointers 150-1 and 150-2 may not be reversed. This is because if those locations pointed to by the first and second pointers 150-1 and 150-2 are changed with each other, then it means that an abnormal situation, which may be either a buffer's overflow (i.e., the write buffer 103 has no storage space left at all) or a buffer's underflow (i.e., the video data that should be accumulated in the write buffer 103 and soon written on the storage media 110 and 111 has been exhausted), has occurred for some reason.

The write buffer 103 may be freed by updating the location pointed to by the second pointer 150-2. That is to say, if the location that was pointed to by the second pointer 150-2 is now pointed to by the first pointer 150-1, new video data can start to be written in the write buffer 103 at that location.

On the other hand, the third and fourth pointers 150-3 and 150-4 point to the terminal locations of the video data that is still accumulated in this write buffer 103 but that has already been written on the storage media 110 and 111, respectively. According to this preferred embodiment, the location pointed to by the second pointer 150-2 agrees with one of the two locations pointed to by the third and fourth pointers 150-3 and 150-4.

When a shooting session is started, the video data gets accumulated in the write buffer 103 on a predetermined data unit basis. And every time the video data is written on a predetermined data unit basis, the CPU 101 updates the first pointer 150-1 by the size of that data unit.

Apparently in parallel with the storage of the video data, the CPU 101 sequentially transfers the video data that has been accumulated in the write buffer 103 to the storage medium I/Fs 104 and 105 and gets the video data sequentially written on the storage media 110 and 111 by way of those storage medium I/Fs 104 and 105, respectively. As soon as the video data is completely written on the storage media 110 and 111, the CPU 101 updates the third and fourth pointers 150-3 and 150-4. In this case, the third and fourth pointer 150-3 and 150-4 are updated so as to point to the locations of the oldest data units that have not been written on their associated storage media yet. At the same time, the second pointer is also updated so as to point to the location of the older one of the two data units that are pointed to by the third and fourth pointers 150-3 and 150-4.

By comparing the third and fourth pointers 150-3 and 150-4 that are retained in itself, the CPU 101 can specify the location of the video data that has been written on both of the storage media with a data unit. If any data unit of the video data has been written on both of the storage media 110 and 111, the CPU 101 frees that data unit up from the write buffer 103. And then the second pointer is updated so as to point to the next data unit.

Hereinafter, it will be described in detail with reference to FIGS. 5 through 12 exactly how the video recorder 100 of this preferred embodiment performs its write operation. First of all, a normal write operation that does not involve compiling recovery information will be described.

FIG. 5 is a flowchart showing the procedure of the write processing to be carried out by the video recorder 100 of this preferred embodiment. Specifically, FIG. 5 shows the details of the processing steps S101 through S108 shown in FIG. 3.

First of all, when the user interface section 107 accepts a user's request to start a write operation, the CPU 101 transfers the video data that has been input to the write buffer 103 by way of the video input section 106 to the storage medium I/Fs 104 and 105. Then, the CPU 101 instructs the storage medium I/Fs 104 and 105 to write the video data that has been transferred to the storage medium I/Fs 104 and 105 on the storage media 110 and 111, respectively (in Step S201).

Next, the CPU 101 frees up the video data that has already been written on the storage media 110 and 111 from the write buffer 103 (in Step S202). On the other hand, the CPU 101 does not free up the video data that has not yet been written on one of the storage media 110 and 111 from the write buffer 103 but just keeps it accumulated there.

Nevertheless, after the write operation has become unable to continue and before the writing resume processing is started, the video data is written on only one of the two storage media, not both of them. Then, the write buffer 103 cannot be freed and the percentage of its storage capacity used becomes always greater than the threshold value. Thus, to avoid such a situation, in that interval after the write operation has become unable to continue and until the writing resume processing is started, if video data has been written on one of the storage media, the CPU 101 frees the write buffer 103 in this preferred embodiment. As a result, the process can advance to Step S204 shown in FIG. 5.

The CPU 101 sees if the data size of the video data that has been accumulated in the write buffer 103 has exceeded the threshold value (in Step S203). In this preferred embodiment, the threshold value is determined by the capacity of the write buffer 103, the video write rate, and the write performances of the storage media. Thus, the threshold value cannot be a single fixed value. In this case, the “write performances of the storage media” may be represented by the lowest writing speed, i.e., a so-called “SD speed class”.

If the CPU 101 has found the data size of the video data not greater than the threshold value (i.e., if the answer to the query of the processing step S203 is NO), then the CPU 101 sees if there is any recovery information being compiled in the main memory 102 (in Step S204). The recovery information being compiled will be described later.

If the CPU 101 has determined that there is no recovery information being compiled in the main memory 102 (i.e., if the answer to the query of the processing step S204 is NO), then the CPU 101 sees if the user has issued an instruction to stop writing through the user interface section 107 (in Step S205). If the CPU 101 has found that no instruction to stop writing has been issued yet (i.e., if the answer to the query of the processing step S205 is NO), then the CPU 101 determines whether or not every storage medium connected to this video recorder 100 (i.e., the storage media 110 and 111 according to this preferred embodiment) has a storage space to store the video data written (in Step S206). This decision on the availability of the storage space is made mainly on the video write rate. That is why the storage space cannot be a single fixed value, either.

If the CPU 101 has found that some storage medium has a storage space to store the video data written (i.e., if the answer to the query of the processing step S206 is YES), then the CPU 101 determines that the operation of writing the video data be continued on that storage medium. And the process goes back to the processing step S201.

However, if the CPU 101 has sensed in Step S205 that the instruction to stop writing has been issued through the user interface section 107 (i.e., if the answer to the query of the processing step S205 is YES) or has discovered in Step S206 that neither the storage medium 110 nor the storage medium 111 has a storage space to store the video data written (i.e., if the answer to the query of the processing step S206 is NO), then the CPU 101 determines that the operation of writing the video data on the storage media be stopped (in Step S207). Then, the CPU 101 sees if there is any recovery information being compiled in the main memory 102 (in Step S208). If the CPU 101 has found no recovery information being compiled in the main memory 102 (i.e., if the answer to the query of the processing step S208 is NO), then the CPU 101 determines that the write operation be finished now.

This is the flow of a normal write operation to be performed without compiling recovery information.

Next, the flow of the processing of compiling recovery information in a situation where the video data has failed to be written on one of the two storage media will be described.

For example, suppose the video data has failed to be written on the storage medium during a write operation. Generally speaking, the internal structure of a storage medium has a fine-line pattern in order to increase its storage capacity as much as possible and data may fail to be written there due to a combination of various factors (including an abnormal voltage during the write operation and some deterioration of the device that processes the storage medium). Nevertheless, even if data has failed to be written in one trial, the write operation could be a success when retried. For that reason, the CPU 101 retries the operation of writing the same data a number of times.

However, even while the operation of writing the same data is retried, the video data generated as a result of shooting gets accumulated one after another in the write buffer 103. In this case, since the video data is not written on both of the storage media 110 and 111, no video data is freed up from the write buffer 103. As a result, the data size of the video data accumulated in the write buffer 103 increases.

If the CPU 101 finds the size of the video data accumulated in the write buffer 103 greater than a threshold value (i.e., if the answer to the query of the processing step S203 is YES), then the CPU 101 sees if at least a part of that video data has been written yet on at least one of the storage media (in Step S209).

Suppose the write buffer 103 has video data that has already been written on the storage medium 110 but that has not been written on the storage medium 111 yet. That is to say, suppose the video data cannot be written on the storage medium 111 in order to avoid using up the storage capacity of the write buffer 103 and missing any part of the video data and to give a higher priority to continuing writing the video data on the storage medium 110.

It should be noted that by reference to the pointers 150-1 through 150-n (where n is 1, 2, 3 or 4) described above, it is easy to determine the data units that have been written on each storage medium. That is to say, it can be determined that the data units have been written on each storage medium to the location pointed to by the pointer 150-3 or 150-4 with respect to the entire video data that is represented by the pointers 150-1 and 150-2. On determining that there is such written data (i.e., if the answer to the query of the processing step S209 is YES), the CPU 101 carries out recovery information compiling processing in Step S210.

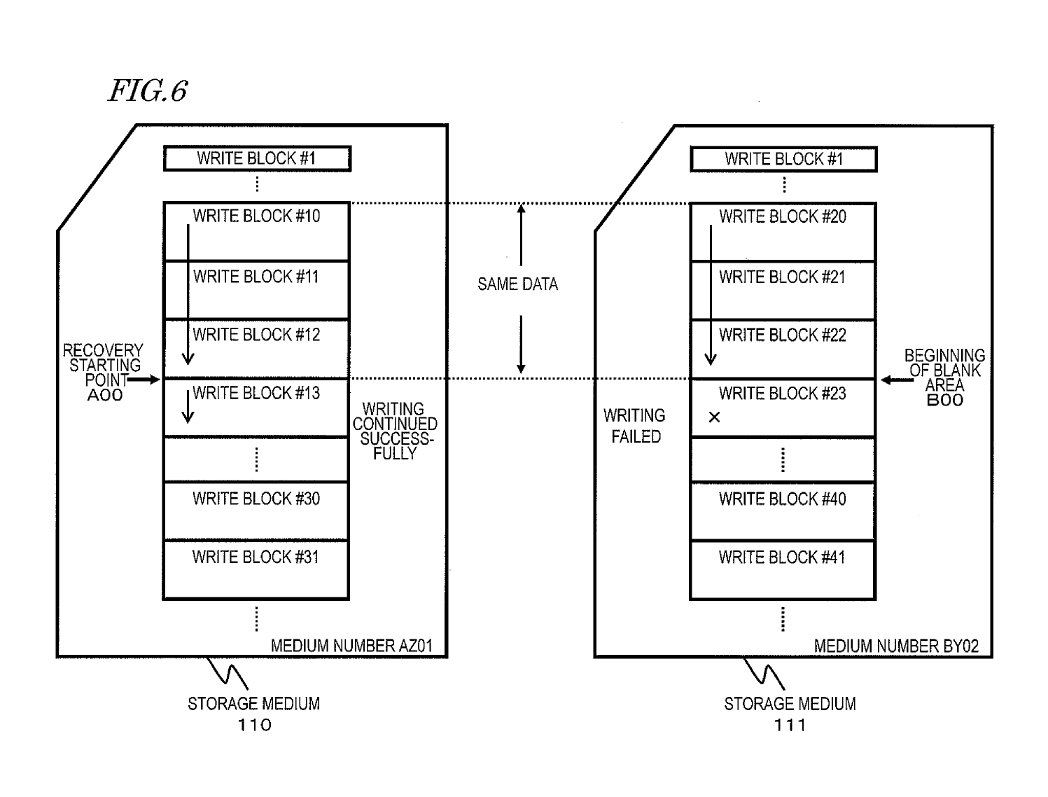

Hereinafter, the recovery information compiling processing of this preferred embodiment will be described with reference to FIGS. 6 through 8. FIG. 6 illustrates how the video data has been written on the storage media 110 and 111.

Suppose the storage medium 110 is identified by its medium number “AZ01” and the storage medium 111 is identified by its medium number “BY02”. The same video data has been written under the file name “0101.avi” on the storage media 110 and 111. Specifically, the same data has been written on write blocks #10 through #12 of the storage medium 110 and on write blocks #20 through #22 of the storage medium 111.

Suppose a block of the following video data should be written on both of the write blocks #13 and #23, and the video data has been written successfully and continuously on the write block #13 of the storage medium 110 but has failed to be written on the write block #23 of the storage medium 111.

In performing the series of write operations shown in FIG. 5, the CPU 101 finds the data size of the video data accumulated in the write buffer 103 greater than the threshold value (i.e., the answer to the query of the processing step S203 shown in FIG. 5 is YES). The CPU 101 also senses, by reference to the pointers 150-2 and 150-3, that some of that video data has already been written on the storage medium 110 but has not been written yet on the other storage medium 111 (i.e., the answer to the query of the processing step S209 shown in FIG. 5 is YES). In that case, the CPU 101 determines that the write operation cannot be continued on that storage medium 111 on which that video data has not been written yet.

If the CPU 101 has known that the write operation has become unable to continue on the storage medium 111, then the CPU 101 determines that the video data stop being written on the storage medium 111.

In this case, the CPU 101 collects various kinds of information that are needed to carry out the recovery processing for matching the content stored in the storage medium 111 with that of the storage medium 110. The main memory 102 stores the recovery information as a collection of all of those kinds of information.

Specifically, the CPU 101 gets information indicating the top address B00 of the write block #23, on which the video data should have been written unless the write operation had become unable to continue on the storage medium 111, as a piece of information indicating the beginning of the blank area. At the same time, the CPU 101 also gets information indicating the top address A00 of the write block #13 of the storage medium 110, on which the video data has been written continuously and which is associated with the write block #23, as a piece of information indicating a recovery starting point. The CPU 101 further gets information representing the medium number “BY02” of the storage medium 111 on which the write operation cannot be continued and information representing the name of the file stored there (i.e., “0101.avi” in this example). As described above, the CPU 101 generates, in the main memory 102, the information indicating the top address B00, the information indicating the top address A00, the information representing the medium number BY02, and the information representing the file name, which have been collected as described above, and manages them as pieces of recovery information. According to this preferred embodiment, the file name is supposed to be included in the recovery information and the blank information. However, the file name does not always have to be included there. Alternatively, by using only a part of the file name of the video data (e.g., the file name except its extension) as the file name to be included in the recovery information and the blank information, the file name of the video data in question may be specified.

FIG. 7 shows an example of the recovery information to be stored in the main memory 102. The values representing the end of the blank area and the recovery end point are still to be determined at this point in time, and therefore, not specified yet. That is to say, this piece of recovery information is still incomplete and being compiled.

Naturally, there is not always only one set of recovery information but there may be multiple sets of recovery information. This is because it can be determined that the write operation cannot be continued on any of the multiple storage media. Another reason is that after it has been determined that the write operation cannot be continued at one write block on one storage medium, it may be determined again that the write operation cannot be continued at another write block on the same storage medium. According to this preferred embodiment, the CPU 101 manages, as a set, the medium number, the file name, the beginning of the blank area, the end of the blank area, the recovery starting point and the recovery end point and manages those sets in the main memory 102 by giving them management numbers such as “management information #1” and “management information #2”, for example.

By representing the beginning of the blank area and the recovery starting point of the recovery information by the addresses of write blocks on a storage medium in this manner, there is no need to retrieve one video file entirely in performing the recovery processing. That is to say, when performing the recovery processing, the CPU 101 does not have to determine on which write block of the storage medium the video data has been written by going back to the beginning of the file. Instead, the CPU 101 just needs to retrieve the video data to recover by reference to the address information of the write block included in the recovery information and then write it on the storage medium 111. As a result, the recovery processing can be speeded up as will be described below.

FIG. 8 is a flowchart showing the procedure of recovery information compiling processing. This is a detailed procedure of the processing step S103 shown in FIG. 3.

First, on finding that the write operation cannot be continued on a storage medium, the CPU 101 determines that the write operation on that storage medium be stopped (in Step S501).

Next, the CPU 101 collects pieces of information, including the information indicating the top address of the write block where the write operation has been stopped, to compile the recovery information (in Step S502).

Then, the CPU 101 writes the recovery information on the main memory 102 in Step S503. If management information has already been stored in the main memory 102, then the CPU 101 stores the recovery information in the main memory 102 with the management number of that management information incremented by one. In this manner, the recovery information compiling processing gets done.

Next, it will be described how to resume a write operation on a storage medium on which the write operation has once become unable to continue.

While continuing the write operations shown in FIG. 5, the CPU 101 sees if the data size of the video data that is accumulated in the write buffer 103 has exceeded a threshold value (in Step S203 shown in FIG. 5). On finding the data size of the video data accumulated in the write buffer 103 not greater than the threshold value (i.e., if the answer to the query of the processing step S203 is NO) and sensing that recovery information being compiled is stored in the main memory 102 (i.e., if the answer to the query of the processing step S204 is YES), the CPU 101 determines that the writing resume processing be carried out (in Step S211).

This processing is carried out on the premise that the phenomenon that data cannot be written on a storage medium is just a temporary one and does not necessarily mean that data cannot be written any longer. That is to say, even if the data cannot be written on a storage medium but as long as there is a sufficient storage space left in the write buffer 103, the CPU 101 determines that the write operation can be resumed on the storage medium on which the write operation has once become unable to continue. Then, the CPU 101 gets the data writing operation retried.

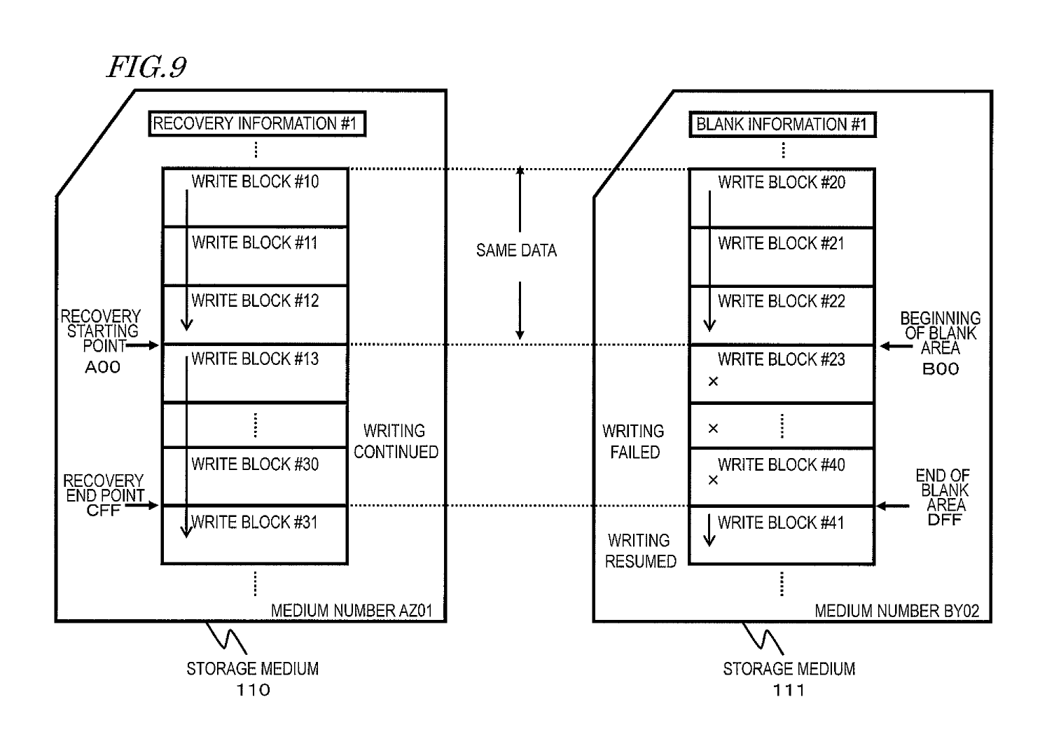

Hereinafter, the writing resume processing of this preferred embodiment will be described in detail with reference to FIGS. 9 through 12.

FIG. 9 illustrates the writing and storage statuses of the storage media 110 and 111 when the operation of writing the video data on the storage medium 111 is resumed. In FIG. 9, any component also shown in FIG. 6 and having substantially the same function as its counterpart is identified by the same reference numeral and description thereof will be omitted herein.

On finding that the write operation can now be resumed on the storage medium 111, the CPU 101 determines where to resume the write operation (which will be referred to herein as a “writing resume point”). According to this preferred embodiment, the writing resume point is not the write block #23 where the write operation had to be suspended the first time around but a write block #41. That is to say, the CPU 101 sets the writing resume point with the range in which the write operation could not be performed left as a storage space (which will also be referred to herein as a “blank area”). Such a range in which the write operation was unable to continue is kept just blank in order to avoid the risk of committing write errors over and over again in spite of repetitive retries because the write block #23 is a defective block. And such a storage space is left in order to speed up the recovery processing to be carried out after the series of write operations.

More specifically, the CPU 101 sets the writing resume point in the following manner. First of all, the CPU 101 specifies a write block on which the write operation is going to be performed with respect to the storage medium 110. In the example illustrated in FIG. 9, that block is the write block #31. And the video data that is going to be written on the write block #31 will also be written on the storage medium 111 in parallel.

Meanwhile, the video data that has been written on the write blocks #13 through #30 of the storage medium 110 has not been written on the storage medium 111 yet. The data size of that video data can be obtained by subtracting the start address A00 of the write block 13 from the last address CFF of the write block 30 (i.e., by calculating (CFF−A00)). Thus, an area that has the same size as that data size may be left as a storage space on which the write operation could not be performed and a point immediately after that storage space may be set to be the writing resume point.

If the beginning of that storage space on which the write operation could not be continued (i.e., the beginning of the blank area) is identified by B00 and if the end of that storage space is identified by DFF, then DFF−B00=CFF−A00 is satisfied. Consequently, the writing resume point DFF of the storage medium 111 is calculated by DFF=B00+CFF−A00. It should be noted that the information indicating the addresses A00 and B00 is already included in the recovery information (see FIG. 7) that is stored in the main memory 102. That is why on setting the writing start point (i.e., the top address of the write block 31) on the storage medium 110, the CPU 101 can specify the writing resume point with respect to the storage medium 111. In this manner, the CPU 101 can determine the writing resume point based on the data size of the video data that has been generated while the write operation is suspended.

Next, the CPU 101 transfers the video data from the write buffer 103 to the storage medium I/F 105 and instructs the storage medium I/F 105 to write that video data transferred on the storage medium 111.

In this case, the CPU 101 adds the end address DFF of the previous write block 40, which precedes the write block 41 where the write operation has been resumed, as the end of the blank area to the recovery information that is stored in the main memory 102. In addition, the CPU 101 also adds the end address CFF of the write block 30 of the storage medium 110 on which the write operation has been performed continuously as the recovery end point to the recovery information. In this case, the end address CFF corresponds to the end of the blank area.

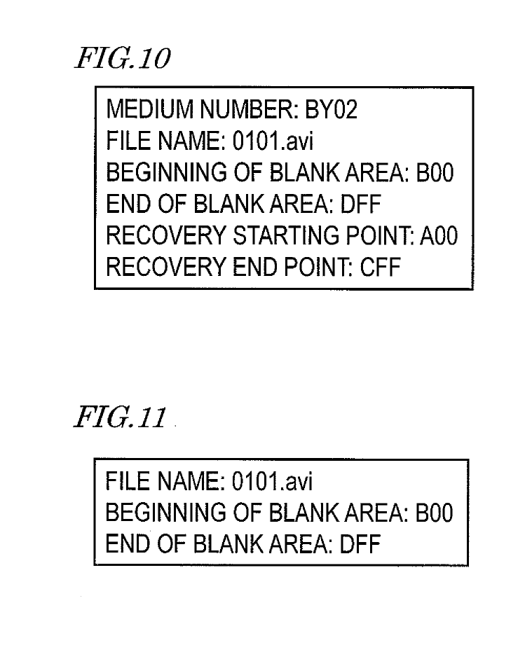

FIG. 10 shows an example of the recovery information to which the end of the blank area and the recovery end point have been added. This recovery information is still stored in the main memory 102. The values of the end of the blank area and the recovery end point, which have not been determined yet in FIG. 7 that shows an example of the recovery information generated by the recovery information compiling process, are now fixed in FIG. 10. That is to say, the recovery information is now completed. And the CPU 101 writes the recovery information completed on the storage medium 110 on which the write operation has been performed continuously.

In this manner, according to this preferred embodiment, the recovery information is written on the storage medium on which the write operation has been continued, and therefore, can be saved just as intended.

Furthermore, in performing the writing resume processing, the blank information is also written. As described above, the blank information is information about the area on which the video data should have been written, i.e., information about the area on which it was determined the write operation could not be continued. And the blank information is written on the storage medium with such an area where the write operation could not be continued.

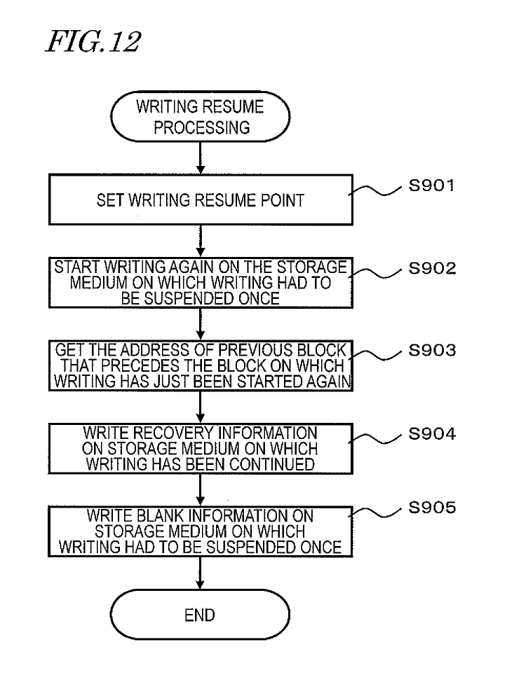

FIG. 11 shows an example of the blank information, which includes information about the file name and information about the beginning and end of the blank area. It can be seen that the beginning and end of the blank area of this example respectively correspond to the starting and end points of the range in which the write operation could not be continued as shown in FIG. 9. Compared to the recovery information shown in FIG. 10, the blank information does not include information about the medium number or information about the recovery starting and end points.

Suppose a situation where video data is discontinued because it has been determined, during a write operation, that the write operation cannot be continued in a certain storage area. Generally speaking, a normal player can play back video only to a point to which its video data has been written continuously. Using the blank information, however, the beginning and end of the blank area can be determined. That is why in that case, the player can play back the video from the writing resume point on with the area in which the write operation could not be continued skipped. Also, if the blank information has been written on a storage medium, a recorder can avoid writing data on the area specified by the blank information. This is because that area is secured in order to recover the video data afterward.

In the example illustrated in FIG. 11, the blank range (i.e., the range that starts at the beginning of the blank area and ends at the end of the blank area) is a physically continuous one. However, this is just an example of the present invention. Actually, the blank range just needs to be logically continuous but does not always have to be physically continuous. For example, by using a file allocation table (FAT) file system, which is one of various file systems currently available, a group of physically discontinuous areas can also be managed as a logically continuous blank range. That is why even if any data has been written by another device on the area specified by the blank information, the video data can still be recovered as long as there is another area of the same data size. It can be said that if the main object is to store (save) the video data safely, just the recovery information needs to be compiled and the blank information is not particularly needed.

FIG. 12 is a flowchart showing the procedure of the writing resume processing. This is a detailed procedure of the processing step S105 shown in FIG. 3.

First of all, on finding that a write operation can now be resumed on the storage medium 111 on which the write operation had to be suspended once, the CPU 101 sets a writing resume point following the procedure described above (in Step S901).

Next, the CPU 101 transfers the video data from the write buffer 103 to the storage medium I/F 105 and then instructs the storage medium I/F 105 to write the video data on the storage medium 111, thereby resuming the write operation (in Step S902).

The CPU 101 defines the end address of the previous write block that precedes the write block of the storage medium 111 on which the write operation has just been resumed to be the end of the blank area, and also defines the end address of the write block of the storage medium 110, which corresponds to the end of the blank area and where the write operation has been performed continuously, to be the recovery end point. Then, the CPU 101 adds information indicating the end of the blank area and information indicating the recovery end point to the recovery information that is managed in the main memory 102 (in Step S903).

Subsequently, the CPU 101 writes the recovery information described above on the storage medium 110 on which the write operation has been performed continuously (in Step S904).

Thereafter, the CPU 101 writes the file name and the beginning and end of the blank area, which are all included in the recovery information described above, as the blank information on the storage medium 111 on which the write operation has just been resumed (in Step S905). In this manner, the writing resume processing gets done.

Now, let's go back to FIG. 5.

On finishing either the recovery information compiling processing (Step S210) or the writing resume processing (Step S211), the CPU 101 sees if the user interface section 107 has accepted a user's instruction to stop writing (in Step S205). After that, the processing from Step S205 on will be carried out just as already described. Also, on finding that the video data stored in the write buffer 103 has no data that has already been written (i.e., if the answer to the query of the processing step S209 is NO), the CPU 101 performs the processing of stopping the write operation on that storage medium (in Step $207). This is because if no data in the write buffer 103 has been written yet, it means that the video data has not been written on any storage medium. And in such a situation, the write operation on every storage medium should be prohibited.

Next, on determining that there be recovery information being compiled in the main memory 102 (i.e., if the answer to the query of the processing step S208 is YES), the CPU 101 regards the end of the blank area and the recovery end point as the end address value of the last write block on which data has been written, and then writes the recovery information and the blank information on the storage media 110 and 111, respectively (in Step S212). And the CPU 101 ends the write operation.

Next, the recovery processing to be carried out after the series of write operations have been performed will be described with reference to FIGS. 9, 10 and 13.

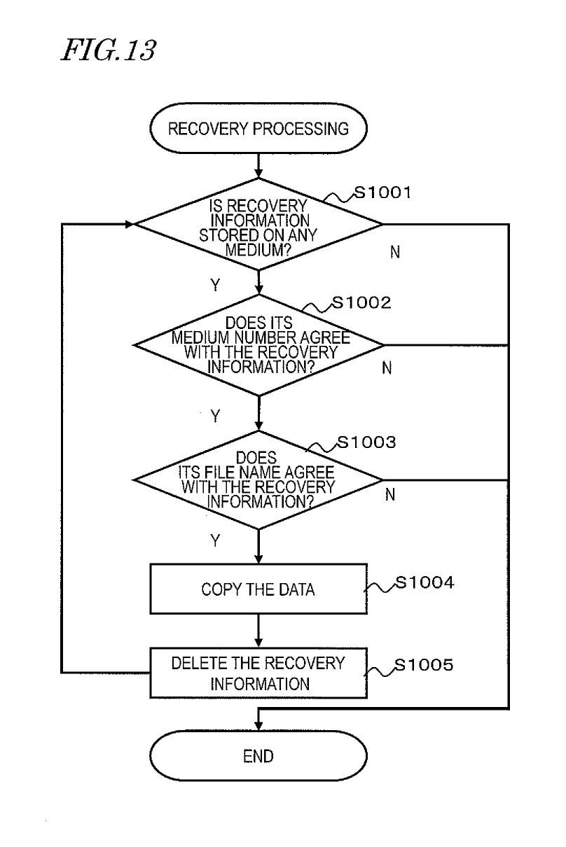

FIG. 13 is a flowchart showing the procedure of the recovery processing. This is a detailed procedure of the processing step S109 shown in FIG. 3.

First of all, the CPU 101 sees if the recovery information is stored on the storage media 110 and 111 (in Step S1001 shown in FIG. 13). In the example illustrated in FIG. 9, the recovery information has been written on the storage medium 110 (in Step S904 shown in FIGS. 10 and 12).

On determining that the recovery information is stored (i.e., if the answer to the query of the processing step S1001 is YES), the CPU 101 sees if a storage medium, of which the medium number agrees with what is specified by the recovery information, is connected to the video recorder 100 (in Step S1002). In the example illustrated in FIGS. 9 and 10, the medium number BY02 that is described as a piece of the recovery information agrees with the medium number of the storage medium 111 that is connected to the video recorder 100.

Next, on finding that the storage medium connected has a medium number that agrees with what is specified by the medium information (i.e., if the answer to the query of the processing step S1002 is YES), the CPU 101 sees if a file, of which the file name agrees with what is specified by the recovery information, is stored on that storage medium (in Step S1003). In the example illustrated in FIGS. 9 and 10, a file with the file name “0101.avi” that is described in the recovery information is stored on the storage medium 111. Thus, a file, of which the file name agrees with what is specified by the recovery information, is stored.

Thereafter, now that it is known that a file, of which the file name agrees with what is specified by the recovery information, is stored (i.e., the answer to the query of the processing step S1003 is YES), the CPU 101 copies the data that covers the range from the recovery starting point through the recovery end point as specified by the recovery information onto the range that starts at the beginning of the blank area and that ends at the end of the blank area (in Step S1004). In the example illustrated in FIG. 9, the CPU 101 copies the data that is stored in the range from the recovery starting point A00 through the recovery end point CFF on the storage medium 110 onto the range from the beginning of the blank area B00 through the end of the blank area DFF on the storage medium 111.

On finishing copying the data, the CPU 101 deletes the recovery information that has been used this time and the blank information specifying the range from the beginning of the blank area B00 through the end of the blank area DFF (in Step S1005). In the example illustrated in FIG. 9, the recovery information #1 stored on the storage medium 110 and the blank information #1 stored on the storage medium 111 are deleted.

Thereafter, the process goes back to the processing step S1001, in which the CPU 1001 once again sees if any recovery information is stored. If the CPU 1001 has determined that there is no recovery information stored (i.e., if the answer to the query of the processing step S1001 is NO) or that no storage medium, of which the medium number agrees with what is specified by the recovery information, is connected (i.e., if the answer to the query of the processing step S1002 is NO), or that no file, of which the file name agrees with what is specified by the recovery information, is stored (i.e., if the answer to the query of the processing step S1003 is NO), then the recovery processing ends.

By using the recovery information in this manner, it can be determined quickly whether or not recovery is needed and the area where data needs to be recovered can be located easily. As a result, the recovery processing can get done more speedily.

As described above, according to this preferred embodiment, if the video data cannot be written on a storage medium for some reason and the write operation on it has to be suspended, then a storage space (or blank area), of which the size is as large as what would be required if the write operation could be continued, is left on that storage medium until the write operation is ready to resume. In the meantime, recovery information that will be needed to recover the missing data is compiled. And when the write operation is ready to resume afterward, the video data that could not be written is written on that storage space left by reference to the recovery information. As a result, the same data can be written on multiple storage media redundantly, and therefore, the video data can be saved safely. On top of that, when the recovery processing is carried out after the series of write operations is over, the size of the video data to recover can be reduced. Consequently, the recovery processing can get done more quickly.

Furthermore, according to this preferred embodiment, the recovery information is written on the storage medium on which the write operation has been performed continuously, and therefore, can be saved safely. What is more, since the recovery information is stored on a removable storage medium, the same recovery processing can be carried out by not only the video recorder 100 but also any other device. That is to say, the video recorder 100 may be dedicated to shooting just like a normal camcorder and the recovery processing may be carried out by another device.

In addition, according to this preferred embodiment, the blank information is written on the storage medium on which the write operation has been suspended. As a result, although normally only video data that has been written continuously can be played back, the storage space (the blank area) may be skipped and the video data that has been written after the write operation has been resumed can be played back.

Furthermore, although the address of a write block on a storage medium is used as a piece of recovery information in the preferred embodiment described above, a byte-by-byte offset from the top of a file may also be used as the recovery information. In that case, the recovery information will define a recovery starting point and the beginning of the blank area that have the same value and also define a recovery end point and the end of the blank area that have the same value. Still alternatively, the recovery starting and end points may be represented by write block address values and the beginning and end of the blank area may be represented by offset values from the top of a file. In this manner, both of these two kinds of values may be stored and used in combination.

Also, in the preferred embodiment described above, the beginning and end of the blank area and the recovery starting and end points are specified only by addresses as shown in FIGS. 7 and 10, for example. In this case, the addresses used belong to the two storage media 110 and 111 that have mutually different address storage spaces. As for the beginning and end of the blank area, it can be determined by the “medium number” which storage medium these points belong to. On the other hand, as for the recovery starting and end points, it cannot be determined which storage medium these points belong to. With no measure taken to overcome this problem, if the storage media were changed halfway, then the recovery processing could be performed with address information that specifies the recovery starting and end points on the newly inserted storage medium that has nothing to do with the original write operation. As a result, the recovery processing could not be performed as intended. Thus, not only the addresses of the recovery starting and end points but also information that can be used to identify their associated storage medium unequivocally may be added as well. Naturally, as for the beginning and end of the blank area, such information that can be used to identify their associated storage medium unequivocally may be added, too.

Furthermore, in the preferred embodiment described above, two storage media are supposed to be connected to the video recorder 100. However, the video recorder 100 may also be connected to three or more storage media as well. In that case, it should be determined on which storage medium the recovery information needs to be written. The decision can be made by seeing (1) if the storage medium stores no blank information, (2) if the transfer rate as defined by the storage medium's standard or rated is higher than any other's or (3) if the storage space left on the storage medium is larger than any other's. If the decision cannot still be made only on the answers to these three questions (1) to (3), the three or more storage media may also be ranked in the ascending order of their management numbers on the storage medium I/Fs connected. It should be noted that the recovery information is usually written on one storage medium but could sometimes be written on two or more storage media.

Moreover, in the preferred embodiment described above, if the size of the video data accumulated in the write buffer exceeds a threshold value, the CPU 101 determines that the write operation cannot be continued on the storage medium. However, this is only an example of the present invention and a different condition may also be set. The condition may also be whether or not the CPU 101 has been notified of the write failure by the storage medium or whether or not the number of times of the failures has exceeded an upper limit.

Furthermore, in the preferred embodiment described above, a file, of which the name agrees with what is specified by the recovery information, is supposed to be recovered. However, a unique identifier may also be used in addition to the file name. For example, a UMID (unique material identifier) as defined by the SMPTE-330 may be given to each file and added to the recovery information and the blank information.

### Embodiment 2

In the first preferred embodiment of the present invention described above, the storage media 110 and 111 are directly connected to the video recorder 100 by way of the storage medium I/Fs 104 and 105, respectively. However, this is only an example of the present invention. Hereinafter, another example of the present invention in which one of the two storage media is in an external device that is connected to the video recorder over a network will be described.

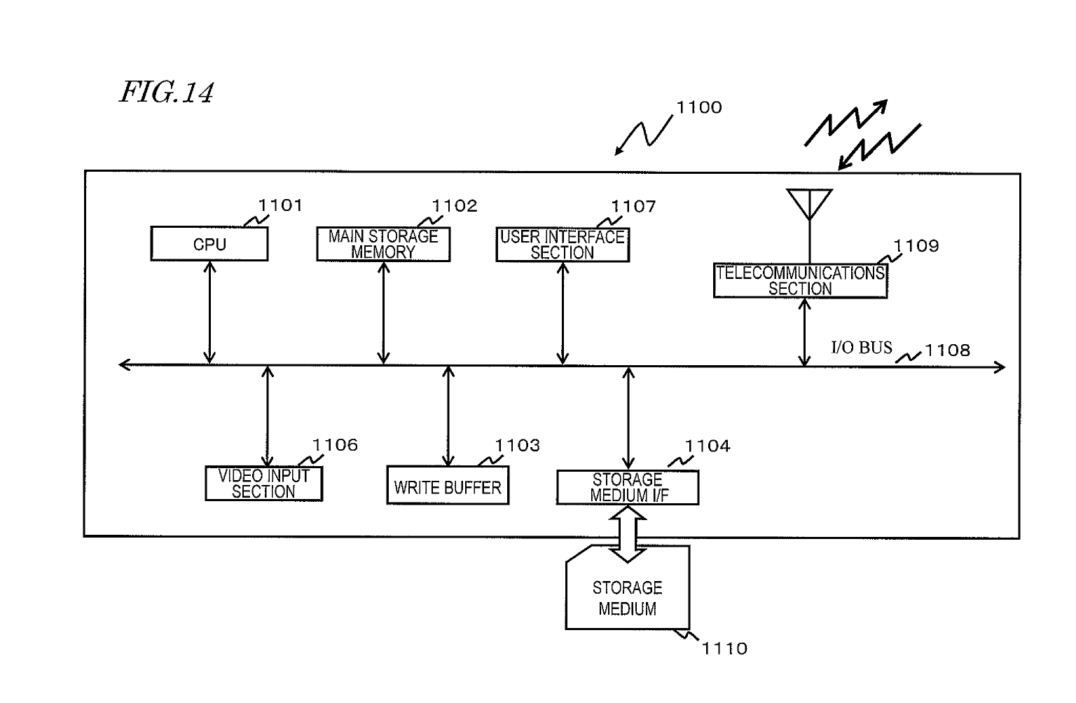

FIG. 14 is a block diagram illustrating a configuration for a video recorder 1100 as a second specific preferred embodiment of the present invention. The video recorder 1100 includes a CPU 1101, a main memory 1102, a write buffer 1103, a storage medium I/F 1104, a video input section 1106, a user interface section 1107, an I/O bus 1108, and a telecommunications section 1109. In the following description, any component of the video recorder 1100 also included in the video recorder 100 of the first preferred embodiment described above and having substantially the same function as its counterpart will be referred to by the same name and description thereof will be omitted herein.

The telecommunications section 1109 is connected to a wireless network such as LTE (Long Term Evolution) or WiMAX (Worldwide Interoperability for Microwave Access) and transmits the video data that is stored in the write buffer 1103 or the storage medium 1110, the recovery information that is stored in the main memory 1102 and the storage medium 1110, and other kinds of information as packets to an external device. Furthermore, the telecommunications section 1109 also uses TCP (Transmission Control Protocol) as a communication protocol for communicating with the external device and receives an ACK (ACKknowledgement) packet, indicating that the external device has received the video data packets successfully, from the external device.

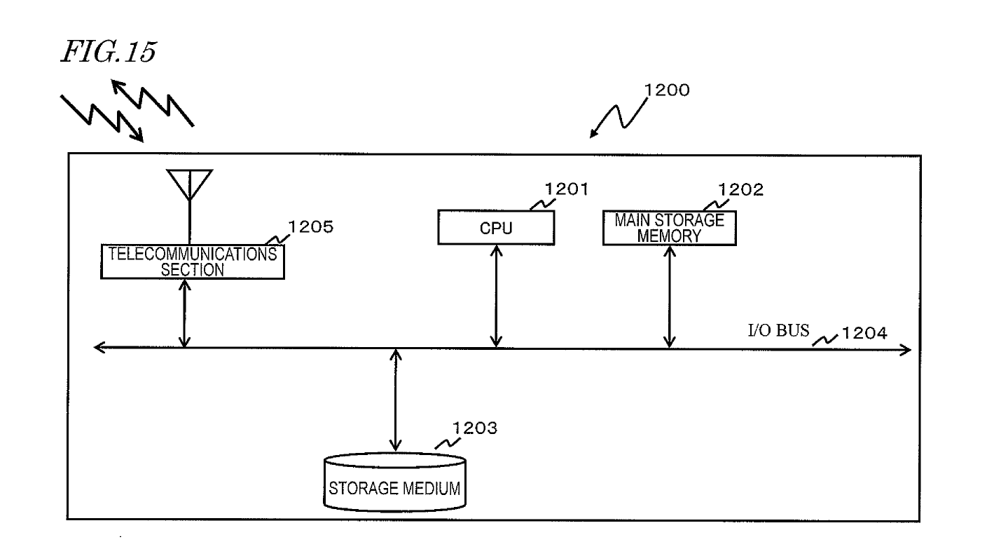

FIG. 15 is a block diagram illustrating a configuration for an external device 1200 according to this preferred embodiment. The external device 1200 includes a CPU 1201, a main memory 1202, a storage medium 1203, an I/O bus 1204, and a telecommunications section 1205. Since this external device 1200 also has a storage medium 1203, it can be said that the external device 1200 is also a sort of recorder similar to the video recorder 100. In the following description, any component of the external device 1200 also included in the video recorder 100 of the first preferred embodiment described above or the video recorder 1100 of this preferred embodiment and having substantially the same function as its counterpart will be referred to by the same name and description thereof will be omitted herein.

According to this preferred embodiment, the storage medium 1203 is a randomly accessible magnetic recording medium with a big storage capacity such as an HDD (hard disk drive) and is connected to the I/O bus 1204. However, this is just an example of the present invention and the type and capacity of the storage medium may also be defined arbitrarily. For example, an optical storage medium such as an optical disc or a semiconductor storage medium such as a flash memory or an SSD (Solid State Drive) may also be used. The storage medium 1203 may be built in the external device 1200 and does not have to be removed frequently. Or the storage medium 1203 may be easily attachable to, and removable from, the external device 1200.

The telecommunications section 1205 receives video data that has been transmitted from the video recorder 1100 over a wireless network, for example, and outputs the data to the main memory 1202. Also, when receiving video data packets from the video recorder 1100 safely, the telecommunications section 1205 sends an ACK packet to the video recorder 1100 to notify the video recorder 1100 of the safe reception.

Hereinafter, it will be described in detail with reference to FIGS. 16 through 20 how the video recorder 1100 of this preferred embodiment performs write operations. The processing performed by the video recorder 1100 is generally the same as the processing shown in FIG. 3. Thus, a series of processing steps corresponding to those of the first preferred embodiment shown in FIG. 5 will be described.

FIG. 16 is a flowchart showing the procedure of write operations according to this preferred embodiment. In the series of write operations according to this preferred embodiment, some processing steps that are substantially the same as their counterparts of the first preferred embodiment (see FIG. 5) will not be described all over again to avoid redundancies. The major difference between the first and second preferred embodiments lies in processing steps S1301, S1302, S1309, S1311 and S1313.

First of all, when the user interface section 1107 accepts a user's request to start a write operation, the CPU 1101 transfers the video data that has been input to the write buffer 1103 by way of the video input section 1106 to the storage medium I/F 1104. Then, the CPU 1101 instructs the storage medium I/F 1104 to write the video data on the storage medium 1110. At the same time, the CPU 1101 also instructs that the same video data as what has been written on the storage medium 1110 be transferred from the write buffer 1103 to the telecommunications section 1109 and then transmitted to the external device (in Step S1301).

Next, the CPU 1101 frees up the video data that has already been written on the storage medium 1110 and the video data that has already been transmitted to the external device 1200 from the write buffer 1103 (in Step S1302). On the other hand, the CPU 1101 does not free up the video data that has not yet been written on the storage medium 1110 or that has not been transmitted to the external device 1200 yet from the write buffer 1103 but just keeps it accumulated there. As to whether or not the video data has been transmitted to the external device 1200, it can be determined by seeing if an ACK packet has been received from the external device 1200. If an ACK packet has been received with respect to each of the packets of the video data transmitted, then the CPU 1101 can determine that the video data has already been transmitted to the external device 1200 completely.

The CPU 1101 sees if the data size of the video data that has been accumulated in the write buffer 1103 has exceeded a threshold value (in Step S1303). If the CPU 1101 finds the size of the video data accumulated in the write buffer 1103 greater than a threshold value (i.e., if the answer to the query of the processing step S1303 is YES), then the CPU 1101 sees if the video data is included in any of the storage media including the storage medium 1203 that is connected to the external device 1200 (in Step S1309).

As to whether or not the video data is included in the storage medium 1203 that is connected to the external device 1200, the CPU 1101 determines by seeing if the video data has been transmitted to the external device 1200. That is to say, if the answer is YES, the CPU 1101 determines that the video data be present on the storage medium 1203. Otherwise, the CPU 1101 determines that the video data be absent from the storage medium 1203.

In this example, the video data is supposed to have already been written on the storage medium 1110 but some video data that has not been transmitted to the external device 1200 yet is supposed to be left in the write buffer 1103. Also, suppose a situation where the video data cannot be transmitted from the video recorder 1100 to the external device 1200 for some reason and the video data has not been written on the storage medium 1203 yet.

If the CPU 1101 finds that there is some data that has already been written (i.e., if the answer to the query of the processing step S1309 is YES), then the CPU 1101 performs recovery information compiling processing (in Step S1310).

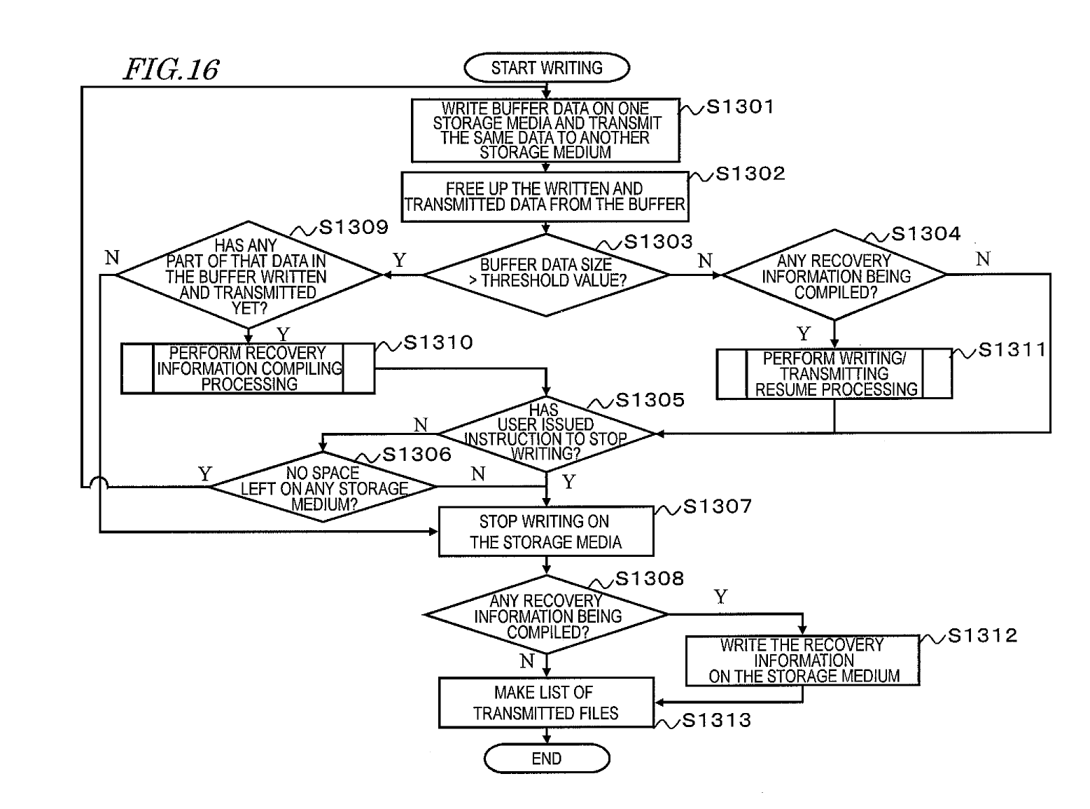

Hereinafter, the recovery information compiling processing of this preferred embodiment will be described with reference to FIG. 17, which illustrates the writing and storage statuses of the storage medium 1110 and the storage medium 1203 that is connected to the external device 1200.

On these two storage media 1110 and 1203, the same video data has been written from the top of the file through an offset of 317440 bytes. The file name of that video data is “0210.avi”.

On sensing that the video data cannot be transmitted to the external device 1200, the CPU 1101 stops transmitting the video data to the external device 1200. In this case, 317440 bytes that is the last offset that has been transmitted successfully is written as a piece of information indicating the beginning of the blank area on the main memory 1102. As for the recovery starting point, the same value of 317440 bytes is written on the main memory 1102. And the CPU 1101 manages those two pieces of information, along with the file name “0210.avi”, as pieces of recovery information on the main memory 1102.

Compared to the first preferred embodiment, although the video data stops being transmitted and the medium number is not included in the recovery information unlike the first preferred embodiment, the recovery information compiling processing of this preferred embodiment is basically the same as that of the first preferred embodiment described above.

By defining the beginning of the blank area by the byte-by-byte offset value as counted from the top of a file as described above, the video data does not always have to be transmitted to the external device 1200 and does not always have to be stored on the storage medium 1203, either. That is to say, there is no need for the external device 1200 to perform a special kind of processing including notifying the video recorder 1100 of the medium number and a write block address of the storage medium 1203. Furthermore, even if the video file that has been written on the storage medium 1203 has been moved to another storage medium, its recovery information is still effective and recovery can also be made on the latter storage medium.

Next, the processing of resuming transmitting video data that has once become unable to transmit will be described.

While continuing the write operations shown in FIG. 16, the CPU 1101 sees if the data size of the video data that is accumulated in the write buffer 1103 has exceeded a threshold value (in Step S1303). On finding the data size of the video data accumulated in the write buffer 1103 not greater than the threshold value (i.e., if the answer to the query of the processing step S1303 is NO) and finding that recovery information being compiled is stored in the main memory 1102 (i.e., if the answer to the query of the processing step S1304 is YES), the CPU 1301 senses that the video data can now be transmitted to the external device 1200 and performs writing/transmitting resume processing (in Step S1311).

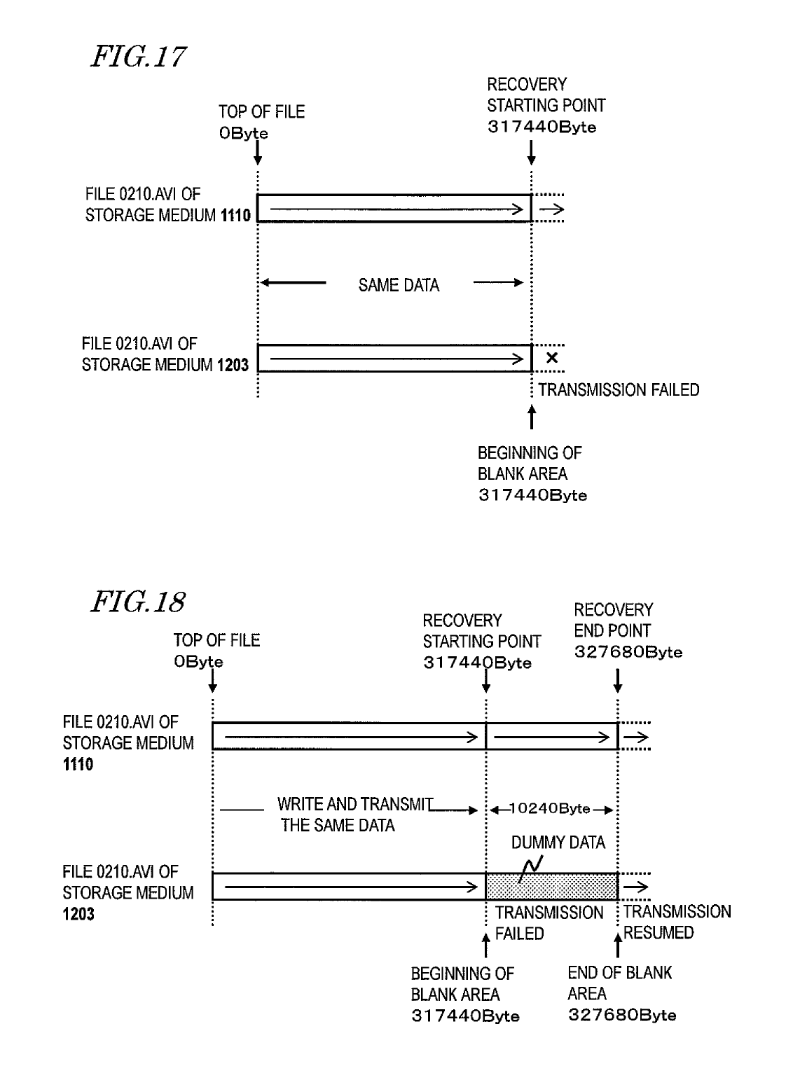

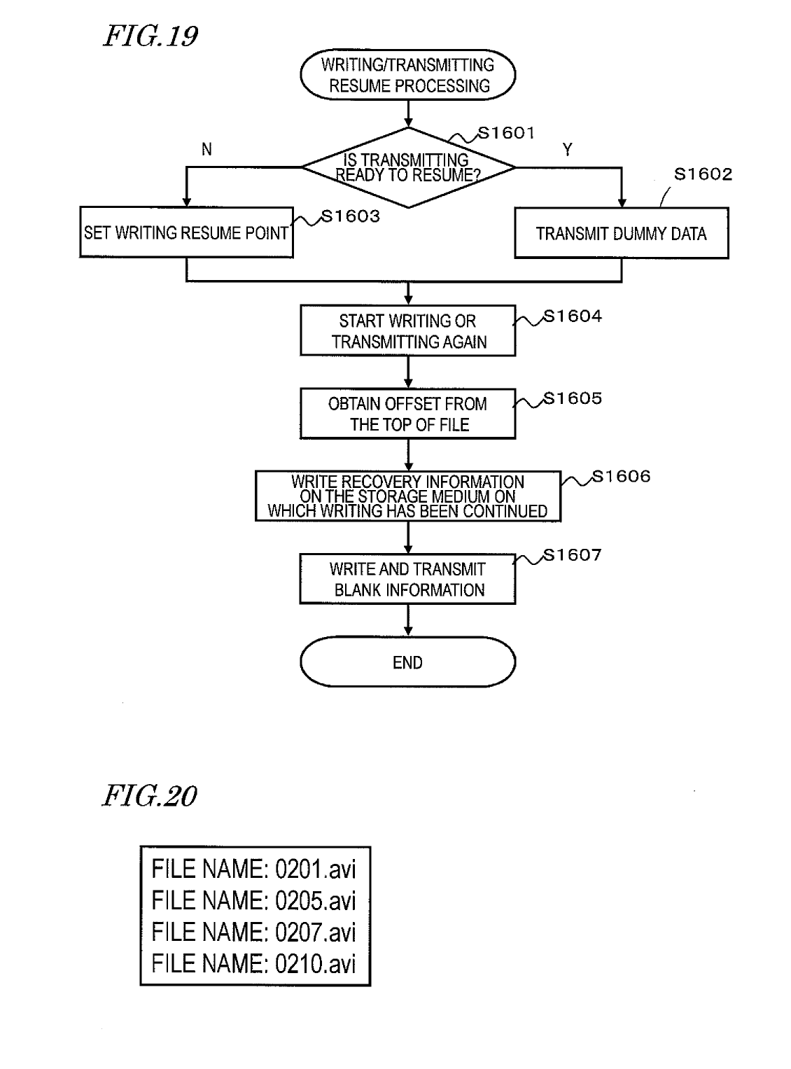

Hereinafter, the writing/transmitting resume processing of this preferred embodiment will be described in detail with reference to FIGS. 18 and 19. FIG. 18 illustrates, as file images, the writing and storage statuses of the storage media 1110 and 1203 when the video data starts to be transmitted again to the external device 1200. In FIG. 18, anything also shown in FIG. 17 and having a similar function to its counterpart's will not be described all over again.

On sensing that the video data can now be transmitted to the external device 1200 once again, the CPU 1101 transmits dummy data so as to leave a storage space on which the video data should have been written while the transmission of the video data was suspended. The data size of the dummy data is defined by that of the missing part of the video data that could not be transmitted or written. In the example illustrated in FIG. 19, the CPU 1101 transmits dummy data, of which the data size is 10240 bytes.

Naturally, that missing part of the video data that could not be transmitted may be transmitted instead of the dummy data. Specifically, in that case, the data that covers the range of 317440 bytes through 327680 bytes of the video data file 0210.avi that is stored on the storage medium 1110 may be transmitted.

According to this preferred embodiment, the dummy data should be transmitted in principle partly because the processing load and processing time that would be needed to retrieve video data from the storage medium 1110 can be saved and partly because the risk of failing to retrieve the video data from the storage medium 1110 can be avoided by doing just that. In these respects, it is effective to transmit the dummy data as described above.

Next, the CPU 1101 instructs the storage medium I/F 1104 to transfer the same video data as what has been written on the storage medium 1110 from the write buffer 1103 to the telecommunications section 1109 and to transmit that video data to the external device 1200.

In this case, the CPU 1101 adds the point with an offset of 327680 bytes as counted from the top of a file, at which the video data starts to be transmitted again, as the end of the blank area and the recovery end point to the recovery information that is stored in the main memory 1102. As a result, the values of the end of the blank area and the recovery end point, which have not been determined yet in the recovery information compiling process, are now fixed and the recovery information is now completed. And the CPU 1101 writes the recovery information thus completed on the storage medium 1110.

By transmitting the dummy data from the video recorder 1110 to the external device 1200 as described above, the storage space, on which the video data should have been written while the transmission was suspended, can be left even without making the external device 1200 perform any special processing. It is not indispensable to actually transmit such dummy data, of which the data size is equal to the storage space to be left. Alternatively, information specifying the size may be transmitted to the external device 1200 and the CPU 1201 of the external device 1200 that has received that size information may secure a storage space of that size on the storage medium 1203.

FIG. 19 is a flowchart showing the procedure of the writing/transmitting resume processing.

On sensing that the operation of writing or transmitting the video data is ready to resume, the CPU 1101 sees if the operation that can be resumed now is writing or transmitting (in Step S1601).

If the CPU 1101 finds that the video data can now be transmitted again (i.e., if the answer to the query of the processing step S1601 is YES), the CPU 1101 transmits dummy data so as to leave a storage space on which the video data should have been written while the transmission was suspended (in Step S1602).

On the other hand, if the CPU 1101 finds that the video data can now be written again (i.e., if the answer to the query of the processing step S1601 is NO), the CPU 1101 sets a writing resume point so as to leave a storage space on which the video data should have been written while the write operation was suspended (in Step S1603).

After that, the CPU 1101 starts again either writing the video data on the storage medium or transmitting the video data to the external device 1200 (in Step S1604).

Next, the CPU 1101 adds the offset value as counted from the top of a file, at which writing or transmitting was resumed, as the end of the blank area and the recovery end point to the recovery information that is managed on the main memory 1102 (in Step S1605).

Then, the CPU 1101 writes the recovery information on the storage medium 1110 on which the write operation has been performed continuously (in Step S1606).

Finally, the CPU 1101 either writes the file name and beginning and end of the blank area, which are included in the recovery information, as pieces of blank information on the storage medium on which the write operation has been resumed or transmits them to the external device 1200 to which the video data has started to be transmitted again (in Step S1607). In this manner, the writing/transmitting resume processing gets done.

On finishing either the recovery information compiling processing (Step S1310 shown in FIG. 16) or the writing/transmitting resume processing (Step S1311 shown in FIG. 16), the CPU 1101 sees if the user interface section 1107 has accepted a user's instruction to stop writing (in Step S1305). On sensing that the user's request to stop writing has been accepted (i.e., if the answer to the query of the processing step S1305 is YES) or that none of the storage media connected to the video recorder 1100 have a storage space that is big enough to continue writing (i.e., if the answer to the query of the processing step S1306 is NO), the CPU 1101 performs the processing of stopping writing on the storage medium and processing of stopping transmitting to the external device 1200 (in Step S1307). Then, if the CPU 1101 finds any some recovery information being compiled in the main memory 1102 (i.e., if the answer to the query of the processing step S1308 is YES), then the CPU 1101 completes the recovery information being compiled and then writes the recovery information on the storage medium 1110 (in Step S1312). After that, the CPU 1101 makes a list of transmitted files and writes the list on the storage medium 1110 (in Step S1313), thus ending the write operations.

FIG. 20 shows a list of transmitted files, which includes the file names of the video files that have been transmitted successfully to the external device 1200. However, this list of transmitted files also includes a file, in which the transmission of the video data was suspended and which needs recovery. As to whether a file needs recovery or not, it can be seen easily by reference to the recovery information or the blank information.

As described above, according to this preferred embodiment, even if one of the two storage media is in an external device that is connected to the video recorder over a network, information required to make a recovery on an interval in which the video data could not be transmitted is also compiled as recovery information. As a result, the same data can be written simultaneously on both the storage medium connected to the video recorder and on the storage medium that is connected over the network for an extended amount of time. Consequently, the recovery processing can get done more quickly as well.

In addition, according to this preferred embodiment, the byte-by-byte offset as counted from the top of file is used as a piece of recovery information. Furthermore, dummy data is transmitted so as to leave a storage space on which video data should have been written while the transmission was suspended. As a result, there is no need for the external device, to which the video data is transmitted, to perform any special processing, and there is no need to determine on what storage medium the video data transmitted should be written, either. That is to say, even if the video file that has been generated by writing the video data moves to another storage medium, the recovery information is still valid and the recovery can also be made on that another storage medium by using the same recovery information.

Also, in the preferred embodiment described above, when the series of write operations is over, a list of transmitted files is made. By reference to this list, every file belonging to each storage medium that is directly connected to the video recorder can be determined to be either transmitted or not transmitted yet. Furthermore, if the list of transmitted files and the recovery information are used in combination, it can also be determined whether or not each of those files needs recovery. For example, if any storage medium has only a little storage space left, then a decision can be made so that transmitted files that need no recovery can be deleted.

Furthermore, in the preferred embodiment described above, during a series of write operations, the video data that is stored in the write buffer 1103 is transmitted to the external device 1200 and written simultaneously on both of the storage media 1110 and 1203. However, not the video data that is stored in the write buffer 1103 but the video data that is stored in the storage medium 1110 may be retrieved and transmitted to the external device 1200.

Optionally, during the series of write operations, the recovery processing may also be carried out in parallel. That is to say, while continuing the series of write operations, the video recorder 1100 may check out the transfer rate of the storage medium 1110, the size of the data accumulated in the write buffer 1103 and the status of the network. And if there is enough margin left, the video recorder 1100 may retrieve, from the storage medium 1110, a part of the video data between the recovery starting point and the recovery end point as defined by the recovery information and may transmit the video data to the external device 1200 to perform the recovery processing.

Furthermore, in the preferred embodiment described above, a file name is supposed to be included in either the recovery information or the blank information. However, a unique identifier may also be used in addition to the file name. For example, a UMID (Unique Material Identifier) as defined by the SMPTE-330 may be given to each file and added to the recovery information and the blank information. Even if the file name is changed while a file is being moved from the storage medium 1203 that is connected to the external device 1200 to another storage medium, the file to recover can be identified with such a unique identifier.

Also, in the preferred embodiment described above, the recovery information is supposed to be written on the storage medium 1110 that is directly connected to the video recorder 1100. However, if the frequency bandwidth of the network is broad enough to transmit data at sufficiently high speeds and with good stability, the recovery information can also be written on the storage medium 1203 of the external device 1200.

Furthermore, in the preferred embodiment described above, video data is supposed to be written on the storage medium 1110 that is directly connected to the video recorder 1100 and on the storage medium 1203 that is either directly connected to, or built in, the external device 1200. However, two or more storage media may be directly connected to the video recorder 1110, two or more external devices may be connected over the network, and two or more storage media may be connected to each external device. In that case, it should be determined on which storage medium the recovery information needs to be written. The decision can be made by seeing (1) if the storage medium is directly connected to the video recorder 1100, (2) if the storage medium stores no blank information, (3) if the frequency bandwidth of the network is broad enough to transmit data to the storage medium on the external device end at sufficiently high speeds and with good stability, or (4) if the storage space left on the storage medium is larger than any other's. If the decision cannot still be made only on the answers to these four questions (1) to (4), the storage media may also be ranked in the ascending order of their management numbers on the storage medium I/F that is directly connected to the video recorder 1100 or in the ascending order of their management numbers on the telecommunications section 1109 that exchanges packets with the external device 1200. It should be noted that the recovery information is usually written on one storage medium but could sometimes be written on two or more storage media.

Furthermore, in the preferred embodiment described above, the dummy data is transmitted so as to leave a storage space on which the video data should have been written while the transmission was suspended. However, instead of actually transmitting the data, the data size of the storage space to be left may be conveyed from the video recorder 1100 to the external device 1200, and the external device 1200 may perform the processing of leaving such a storage space on the storage medium 1203.

Also, in the preferred embodiment described above, the video recorder 1100 and the external device 1200 are supposed to be connected together over a wireless network. However, the video recorder 1100 and the external device 1200 may also be connected together over a wired network such as Ethernet™.

In the first and second preferred embodiments of the present invention described above, the recovery information is supposed to be written on the storage medium on which the write operation has been performed continuously. If the write operation has been performed continuously on multiple storage media, however, the recovery information may be written on either all of those storage media or only one of them. In the latter case, it may be determined, by the degrees of reliability of the storage media on which the write operation has been continued, on which storage medium the recovery information should be stored. For example, the smaller the number of times of write failures that have occurred on a storage medium so far, the higher the degree of its reliability should be. Or the earlier the date and time of a write failure that occurred on a storage medium last time, the higher the degree of reliability of that storage medium should be. In any case, the degrees of reliability may be determined with respect to a predetermined standard.

The present invention may also be carried out as a computer program for operating a recording system. For example, the CPU 101 of the video recorder 100 of the first preferred embodiment described above and the CPU 1101 of the video recorder 1100 of the second preferred embodiment described above may also be implemented as a piece of hardware such as a DSP in which a computer program is installed in a semiconductor integrated circuit. Such a computer program includes instructions to carry out the procedure represented by at least one of the flowcharts shown in FIGS. 3, 5, 8, 12 and 13 as for the first preferred embodiment described above. As for the second preferred embodiment, on the other hand, the computer program includes instructions to carry out the procedure represented by at least one of the flowcharts shown in FIGS. 16 and 19. In any case, such a computer program may be circulated on the market by being stored on a storage medium such as a CD-ROM or downloaded over telecommunications lines such as the Internet.

A recorder according to any of various preferred embodiments of the present invention described above can write video data on two storage media redundantly. If a write operation on one of the two storage media has to be suspended for some reason, then a storage space is left on that storage medium. And when the write operation is ready to resume on that storage medium, the video data that should have been written there is written on that storage space left, thereby speeding up the recovery processing. In the meantime, recovery information is also compiled in order to recover the data that should have been written on the storage space left. And then the recovery information is written on the other storage medium on which the video data that should have been written on that storage space of the storage medium has already been written. As a result, the recovery information can be saved safely and applied to a camcorder, for example, which is very beneficial.

While the present invention has been described with respect to preferred embodiments thereof, it will be apparent to those skilled in the art that the disclosed invention may be modified in numerous ways and may assume many embodiments other than those specifically described above. Accordingly, it is intended by the appended claims to cover all modifications of the invention that fall within the true spirit and scope of the invention.

This application is based on Japanese Patent Applications No. 2011-026832 filed on Feb. 10, 2011 and No. 2012-005337 filed on Jan. 13, 2012, the entire contents of which are hereby incorporated by reference.

What is claimed is:

1. A recording system comprising:
a write buffer configured to temporarily accumulate content data to be generated sequentially; and
a controller configured to write the content data that is accumulated in the write buffer on each of multiple storage media, including first and second storage media, in parallel with each other,
wherein if there is a period in which the content data has failed to be written on the first storage medium but has been written successfully on the second storage medium,
the controller finds, on the first storage medium, a storage space, of which the size is equal to or greater than that of partial data that is the content data that has been written successfully on the second storage medium during the period, and writes recovery information on at least one of the storage media other than the first storage medium,
the recovery information including: a first piece of information that identifies the first storage medium on which the partial data has failed to be written; a second piece of information that specifies the storage space; and a third piece of information that defines an area on the second storage medium on which the partial data has been written.

2. The recording system of claim 1, wherein the controller generates, as the second piece of information, information that indicates the beginning and end of the storage space.

3. The recording system of claim 2, wherein the controller generates, as the third piece of information, information that defines the starting point and the end point of the area on the second storage medium on which the partial data has been written.

4. The recording system of claim 1, wherein the controller writes blank information, including the second piece of information that specifies the storage space, on the first storage medium.

5. The recording system of claim 1, wherein the write buffer deletes, on a predetermined data unit basis, the content data that has been written on the first and second storage media, and
wherein the controller determines, based on the data size of the content data that is accumulated in the write buffer, that the content data is unable to be written on the first storage medium.

6. The recording system of claim 1, wherein if the data size of the content data that is accumulated in the write buffer does not exceed a predetermined threshold value, the controller determines that the content data is ready to start being written on the first storage medium again and retries the operation of writing the content data.

7. The recording system of claim 3, wherein if the recovery information has been written on at least one of the storage media other than the first storage medium,
the controller retrieves the recovery information,
determines whether the first storage medium, which is identified by the first piece of information and on which the partial data has failed to be written, is connected or not, and
if the first storage medium is connected,
the controller retrieves the partial data from the area on the second storage medium by reference to the third piece of information, and writes the partial data retrieved on the storage space that is specified by the second piece of information.

8. The recording system of claim 1, wherein if there is a period in which the content data has failed to be written on the first storage medium but has been written successfully on the second storage medium and an n^{th} storage medium (where n is an integer that is equal to or greater than three), the controller writes the recovery information on both of the second storage medium and the n^{th} storage medium.

9. The recording system of claim 1, wherein if there is a period in which the content data has failed to be written on the first storage medium but has been written successfully on the second storage medium and an n^{th} storage medium (where n is an integer that is equal to or greater than three), the controller writes the recovery information on one of the second and n^{th} storage media that has turned out to have the higher degree of reliability than the other according to a predefined standard.

10. The recording system of claim 3, wherein the write buffer and the controller are arranged inside a single housing, and
wherein multiple storage media are attachable to, and removable from, the recording system.

11. The recording system of claim 10, further comprising a video input section configured to receive sequentially, as the content data, video data of a subject that has been shot.

12. The recording system of claim 1, comprising:
a first recorder, which includes the write buffer, the controller and a first telecommunications section configured to transmit the content data and which writes the content data on one of the first and second storage media, and
a second recorder, which includes a second telecommunications section configured to receive the content data from the first recorder and configured to write the content data received on the other of the first and second storage media.

13. A recording method to be performed by a recording system that includes:
a write buffer configured to temporarily accumulate content data to be generated sequentially; and
a controller configured to write the content data that is accumulated in the write buffer on each of multiple storage media, including first and second storage media, in parallel with each other,
wherein if there is a period in which the content data has failed to be written on the first storage medium but has been written successfully on the second storage medium,
the method comprises the steps of:
making the controller find, on the first storage medium, a storage space, of which the size is equal to or greater than that of partial data that is the content data that has been written successfully on the second storage medium during the period, and
making the controller write recovery information on at least one of the storage media other than the first storage medium,
the recovery information including: a first piece of information that identifies the first storage medium on which the partial data has failed to be written; a second piece of information that specifies the storage space; and a third piece of information that defines an area on the second storage medium on which the partial data has been written.

14. A computer program, stored on a non-transitory computer-readable medium, to be executed by a computer of a recording system that includes:
a write buffer configured to temporarily accumulate content data to be generated sequentially; and
the computer configured to write the content data that is accumulated in the write buffer on each of multiple storage media, including first and second storage media, in parallel with each other,
wherein if there is a period in which the content data has failed to be written on the first storage medium but has been written successfully on the second storage medium,
the computer program is defined to make the computer perform the steps of:
finding, on the first storage medium, a storage space, of which the size is equal to or greater than that of partial data that is the content data that has been written successfully on the second storage medium during the period, and
writing recovery information on at least one of the storage media other than the first storage medium,
the recovery information including: a first piece of information that identifies the first storage medium on which the partial data has failed to be written; a second piece of information that specifies the storage space; and a third piece of information that defines an area on the second storage medium on which the partial data has been written.
